(19) United States
(12) Patent Application Publication
(10) Pub. No.: US 2025/0077629 A1
(43) Pub. Date: Mar. 6, 2025

(54) RIGHTS MANAGEMENT FOR DIGITAL ASSETS

(71) Applicant: Nvidia Corporation, Santa Clara, CA (US)

(72) Inventor: Michael Kass, Los Altos Hills, CA (US)

(21) Appl. No.: 18/460,909

(22) Filed: Sep. 5, 2023

(51) Int. Cl. G06F 21/10; G06F 21/64; H04L 9/00

(52) U.S. Cl. CPC G06F 21/1015; G06F 21/64; H04L 9/50; H04L 2209/603

(57) ABSTRACT

Approaches presented herein provide for the management of owned digital assets. An entity may obtain ownership of (or other rights to) a unique digital asset, and information regarding this ownership can be stored to a trusted registry, such as a blockchain. The only true copy of this digital asset is stored to a secure environment, with no identical copy of this digital being available outside this secure environment. A party may be able to obtain a copy, version, or view of this digital asset that will differ in at least some way from the true asset. For a 3D model asset, this may include providing only a 2D image of that 3D model that was rendered in a secure environment. In this way, a true reconstruction of the 3D model will be unable to be generated outside of the secure environment. If the asset was obtained through procedural generation, information about the generation (and ownership of one or more aspects of that generation) may be stored to the registry as well.

### BACKGROUND

There is increasing interest in the ownership of various digital assets, such as images and digital audio recordings. In one currently popular approach, a person or entity can purchase a non-fungible token (NFT), which is a digital asset for which the security or ownership of the asset is indicated in a trusted distributed ledger, such as a blockchain. For example, a person can obtain ownership of a digital image, and that ownership can be recorded to a blockchain such that ownership of that digital image can be verified at any time. In many instances, however, the digital asset to which ownership is obtained has already been made publicly available, such that many other people or entities will have similar or even identical copies to the asset for which ownership has been obtained or transferred. In some cases, an NFT only provides a link to a copy of a digital asset that is otherwise publicly available. Thus, while a given person or entity may be considered to be the true “owner” of a digital asset, there may be many other people who also have identical copies of that digital asset, such that the true or perceived value of purchasing that digital asset may be minimal, and there may be few if any limitations on what non-owners can do with their identical copies of the asset.

### BRIEF DESCRIPTION OF THE DRAWINGS

Various embodiments in accordance with the present disclosure will be described with reference to the drawings, in which:

FIGS. 1A and 1B illustrate approaches for managing ownership of a digital asset, in accordance with at least one embodiment;

FIGS. 2A and 2B illustrates example system for managing ownership of one or more digital assets, in accordance with at least one embodiment;

FIG. 3 illustrates an example system for enabling a version of a digital asset to be included in a virtual experience, according to at least one embodiment;

FIGS. 4A, 4B, 4C, 4D, and 4E illustrate different views or versions of an asset that can be generated in a secure environment, according to at least one embodiment;

FIGS. 5A and 5B illustrate example processes for managing ownership of a digital asset, according to at least one embodiment;

FIG. 6 illustrates components of a distributed system that can be used to manage ownership of digital assets, according to at least one embodiment;

FIG. 7A illustrates inference and/or training logic, according to at least one embodiment;

FIG. 7B illustrates inference and/or training logic, according to at least one embodiment;

FIG. 8 illustrates an example data center system, according to at least one embodiment;

FIG. 9 illustrates a computer system, according to at least one embodiment;

FIG. 10 illustrates a computer system, according to at least one embodiment;

FIG. 11 illustrates at least portions of a graphics processor, according to one or more embodiments;

FIG. 12 illustrates at least portions of a graphics processor, according to one or more embodiments;

FIG. 13 is an example data flow diagram for an advanced computing pipeline, in accordance with at least one embodiment;

FIG. 14 is a system diagram for an example system for training, adapting, instantiating and deploying machine learning models in an advanced computing pipeline, in accordance with at least one embodiment; and

FIGS. 15A and 15B illustrate a data flow diagram for a process to train a machine learning model, as well as client-server architecture to enhance annotation tools with pre-trained annotation models, in accordance with at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The systems and methods described herein may be used by, without limitation, non-content generation and gaming systems, autonomous vehicles, semi-autonomous vehicles (for example, in one or more advanced driver assistance systems (“ADAS”)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training or updating, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, generative AI with large language models (“LLMs”), light transport simulation (for example, ray-tracing, path tracing, etc.), collaborative content creation for three-dimensional (“3D”) assets, cloud computing and/or any other suitable applications.

Disclosed embodiments may be comprised in a variety of different systems such as content generation or gaming systems, automotive systems (for example, a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more Virtual Machines (“VMs”), systems for performing synthetic data generation operations, systems implemented at least partially in a data center, systems for performing conversational AI operations, systems for performing generative AI operations using LLMs, systems for performing light transport simulation, systems for performing collaborative content creation for 3D assets, systems implemented at least partially using cloud computing resources, and/or other types of systems.

Approaches in accordance with various embodiments can provide for management, support, and other such tasks relating to ownership of digital assets, such as non-fungible tokens (NFTs). A digital asset as used herein can refer to any collection of data, or digital representation, that corresponds to a type of content, such as an image, audio sample, animation, artistic creation, virtual character, behavior, and the like, as may include, without limitation, images, video files, audio files, and multimedia files. Such assets can include three-dimensional (3D) assets such as 3D digital models, but can also include other types of assets as well, such as 2D images and 4D models with behaviors, among other such options. In at least one embodiment, when ownership of a digital asset is obtained, whether through creation, a transaction, or otherwise, that asset can be stored to a secure location. This asset may include a unique asset that has always been stored in a secure environment, was generated in a secure environment, or was otherwise not made available for public consumption, other than potentially in a form or with a quality that is not the same as, and in many cases of lower quality than, an original copy of this unique asset. Ownership of such an asset can be logged to a verifiable registry or protected repository, such as a blockchain or secure database, or any registry in which data is protected or secured from being changed without authorization or permission, and where an accuracy of data can be verified in some way. If the asset was generated using procedural generation, for example, then information regarding aspects of the procedural generation can be written to the registry as well. The asset can be maintained in a secure location or environment, such as on a secure server or in a secure repository, and only lower-quality versions (in dimensionality, resolution, size, etc.), or versions that differ from an original version in one or more aspects, be generated from this secure asset from within the secure environment. Such a generated version of an asset can be provided to users in that lower quality or different form outside the secure environment, at least for authorized users or entities, or those who otherwise have permission or rights to receive these lower-quality versions. For a 3D model asset, this may include providing one or more 2D renderings, where a user or requestor only receives the pixel data that was rendered on the secure server or in the secure environment. The user may be able to specify certain aspects of the model to be used to generate these 2D renderings, but the rendering will always be done from a secure environment in at least some embodiments. This can include, for example, a user being able to use these rendered images to display views of digital assets to which they have access rights or ownership, such as in a virtual gallery or experience, without anyone other than the true owner of the asset having access to the full, original, high-quality asset. This may include other types of assets as well, such as high resolution 2D images or 4D models with motion characteristics, as well as audio or other such assets. Where the asset was generated using procedural generation, a user might be able to retain ownership or rights in certain aspects of the generation, such as a text prompt used with a specific version of a generative model that was trained on a specific dataset. Information about the generative process used to generate the asset may be written to a registry for provenance or validation purposes, and may be stored in protected form in order to allow for validation—without publicly exposing the aspects that were used to generate the unique digital asset.

Various other such functions can be used as well within the scope of the various embodiments as would be apparent to one of ordinary skill in the art in light of the teachings and suggestions contained herein.

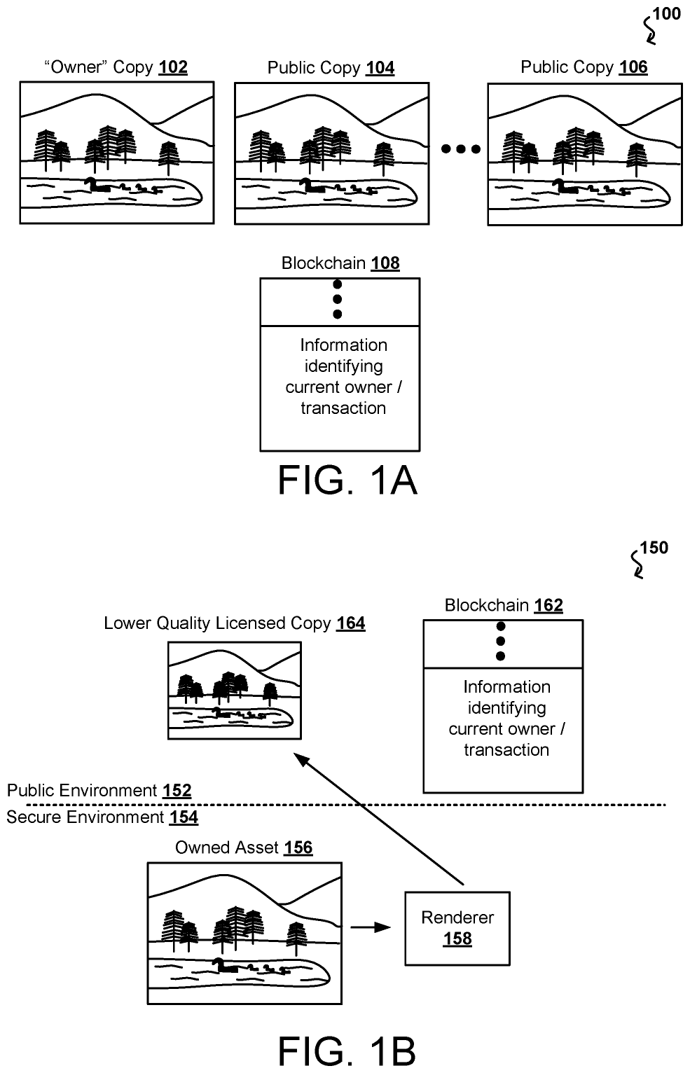

There are various situations in which people or entities may wish to obtain ownership of digital assets. These may include, for example, wanting exclusive use of those assets for various purposes, an ability to invest in digital assets, or bragging rights to owning a popular or important digital asset. As an example, a person may purchase, or otherwise obtain, rights to a non-fungible token (NFT). An NFT generally refers to a financial security associated with a digital asset, wherein ownership of that NFT is recorded to a distributed or verifiable ledger, such as a blockchain 108 as illustrated in FIG. 1A. By recording ownership of an NFT in a blockchain, as a verifiable and publicly disclosed transaction, the true ownership of that digital asset can be readily determined. In some instances, an owner may obtain certain rights to this NFT, such as copyright in this NFT, while in other instances the owner may instead only obtain rights to “own” that particular NFT.

While such ownership may still be desirable in many instances, this has proven to be a disappointing concept of ownership for many. For example, there may be a digital asset such as a two-dimensional image, to which a person obtains ownership. This ownership can be recorded on a blockchain that points to (or otherwise indicates with sufficient specificity) this digital asset. Unfortunately, in many instances this digital asset may be universally visible in full. The owner may obtain a copy of (or link to) the digital asset, illustrated in FIG. 1A, as an owner copy 102. In many instances, however, there will be other copies 104, 106 of that digital asset that are publicly available or available to others, which may be exact copies of that digital asset, such as a digital copy of the image with the same resolution, color depth, and other such aspects. Thus, while the owner of this NFT will obtain a record of ownership, there will be other copies publicly available such that the value of the NFT, or ability to control use of the digital asset, may be limited.

Accordingly, approaches in accordance with various embodiments can be used to provide for true ownership of digital assets, which may be more in line with an owner's concept of ownership. Such an approach can include, for example, storing a unique copy of a digital asset to a secure location, such that no unauthorized copy of the digital asset is available or transmitted outside the secure location unless otherwise specifically authorized by the owner, or by an authorized party acting on behalf of the owner. If a user or entity (other than the owner) obtains rights or access to view or use that digital asset, then a version of that digital asset can be provided that differs in at least one way from the unique digital asset that is owned and stored in the secure environment. This can include, for example, providing only a lower resolution image or audio clip, or only providing pixels for a 2D rendering of a 3D model or 4D model (with some type of behavior or change information over time), among other such options. By ensuring that a unique asset is stored in a secure location, that only lower-quality or different versions of that asset are provided outside that environment, and any generation of these other versions is performed within that secure environment, true ownership can be maintained at least in part because no other person or entity will have a true and identical copy of the securely-stored asset (unless so authorized by the owner). A lower-quality version can correspond to a version that differs (typically being lower in value) in at least one quality metric, such as a resolution, color depth, bit rate, bit depth, size, dimension, or compression. By obtaining one or more differing versions of a secure asset, an entity may attempt to recreate or reconstruct a similar copy of that digital asset, but this similar will be highly unlikely to be an exact copy of the digital asset, which can provide greater rights and benefits to owning the digital asset. Even if an owner does not obtain copyright to the digital asset, the owner will have at least some control (within the scope of ownership) over how the original digital asset is used by being able to maintain control over the only “true” copy. In some embodiments, aspects of a lower quality version can be determined based upon various factors, such as rules for generating versions for specific users, intended uses, or types of licenses. In other embodiments, machine learning may be used to infer versions that appear similar to unique digital assets but that differ from the original assets in ways that would make reconstructing the original assets difficult based only on the generated versions resulting from these inferences.

FIG. 1B illustrates an example configuration 150 of components that can be used to manage ownership of a digital asset 156. In this example, a unique copy of an owned asset 156 is stored to a secure environment 154. To preserve the uniqueness of this owned asset 156, it can be ensured that no identical copy was previously made available outside this (or another) secure environment, other than potentially when using a secure transfer mechanism to transfer between secure environments. It can also be ensured that, at least for a time in which uniqueness of this digital asset is to be preserved, no identical copy of this asset (or the asset itself) is exposed or available outside this secure environment 154, such as in a public environment 152. This secure environment 154 may be provided or managed by the owner of this asset, or may be a secure environment provided by another entity, such as a multi-tenant resource provider or cloud provider, which has guaranteed to the owner that the owned asset 156 will remain in the secure environment, such as by being stored to a secure database and managed using a secure server with at least minimum security mechanisms in place to prevent unauthorized access.

In this example, information indicating ownership of this digital asset 156 can be stored to a distributed ledger or other verifiable repository, such as may be written to a blockchain 162. This may include a blockchain that indicates, with sufficient specificity, the owned asset 156, as well as corresponding ownership or transaction information that can be verified. This blockchain can be available outside the secure environment 154, such as in a public environment 152 or other environment that is not guaranteed to be secure, such that ownership of the digital asset may be determined by a person or entity outside the secure environment 154. It might be the case that a person or entity wants to obtain a copy or version of this owned digital asset 156. Such a lower quality licensed copy 164 may be used for various purposes, such as for personal display, inclusion in an offering or product such as a game or video, or viewing through an interactive virtual (or augmented) experience, among other such options. In such a situation, this user or entity may (directly or indirectly) contact the owner, or an entity associated with the owner, to request a copy of the owned asset 156. If it is determined that the requestor is to obtain access to such a copy, it can be ensured that the requestor only receive access to a copy—such as a lower quality licensed copy 164—that is of lower quality than, or otherwise different from, the owned asset 156 in at least some way. For a 2D asset, such as a high quality image, this may include a copy of the 2D asset that is lower in resolution, size, or color depth, or may include a cropped portion of the owned asset. For a 3D owned asset, this may include only 2D images or views rendered of this 3D asset. In one or more embodiments, aspects of the 2D images or views may be limited along or more parameters (e.g., a maximum or minimum depth, a color scheme, or a range of perspectives, etc., at which the image or view may be rendered). For a 4D asset, such as a model that has a determined motion or behavior over time, this may include a sequence of 2D images that are representative of that motion. For an audio asset, this may include a stream of the audio that is of lower bitrate or that has at least a minimum amount of compression. Various other differences can be applied for other types of digital (or at least partially digital) assets in accordance with various embodiments. For image-related assets, regardless of dimension, a renderer 158 in the secure environment can be tasked with rendering these lower-quality versions from within the secure environment 154. The rendered version can then be provided as a set or stream of pixel data, for example, such that no graphics calls or other information than the pixel data can be passed outside the secure environment that could potentially be used to reconstruct the digital asset, such as may be used to reconstruct a 3D asset from graphics API calls for generating one or more 2D views of that 3D asset. Once pixel (or other) data for a lower-quality version of the owned asset 156 is exposed outside the secure environment 154, that data can be used by a receiving party to attempt to recreate the owned asset 156, but as mentioned this reconstruction will likely be perceptibly distinct from the owned asset 156 because the reconstruction will be based on lower quality or different versions of the owned asset, such that the reconstruction will have to guess or predict at least some of the data for the reconstruction. In this way, the owner can be ensured in most instances to be the unique and only owner—e.g., will retain the reservation of at least some additional rights—of the original owned asset 156, with any other party or entity only having a lower-quality or different copy or approximation of the original asset.

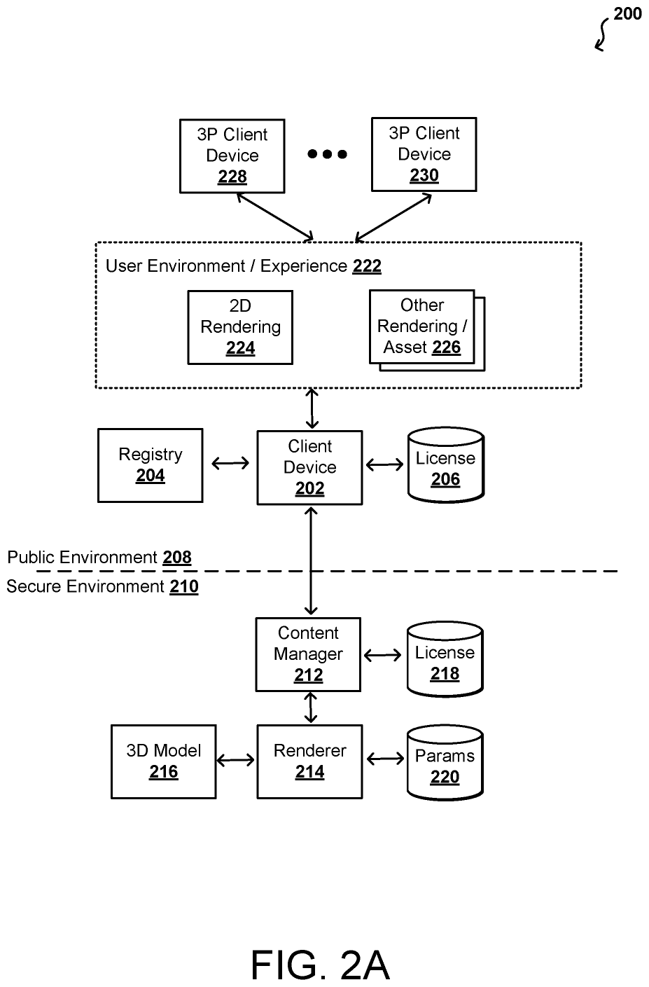

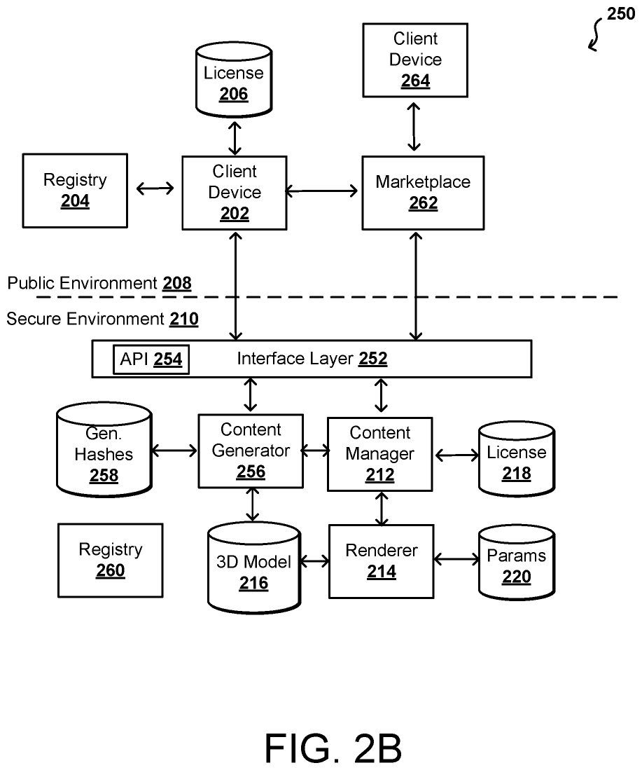

FIG. 2A illustrates example components of one such system 200 that can be used to manage ownership of one or more digital assets on behalf of one or more owners of those assets. In this example, a person or entity (hereinafter the “owner”) has obtained rights to a unique digital 3D model 216, although other types of digital assets could be owned and managed as well as discussed herein. The unique 3D model 216 can be stored to a secure environment 210, such as to a secure server or storage device. As with various other examples presented herein, the 3D model 216 has not been made available outside this secure environment 210 or another secure environment, other than potentially during a secure transfer between secure environments, and no exact copy of the 3D model has been provided to an entity outside of these secure environments, such that the only true and exact copy or instance of this 3D model 216 is within this secure environment 210 under at least some control of the owner, as well as any operator or provider of the secure environment 210. If the 3D model 216 was obtained from another entity, that entity may have been required to delete, destroy, or modify any other copy of the 3D model such that there is only one unique and true copy or instance that is under control of the owner. In other instances, any other parties having an exact copy as authorized by the owner may be required to also store their copy to a secure environment. As with other examples presented herein, any update in ownership can be reflected in a registry 204, such as a blockchain, or other verifiable ledger, repository, or database, such as may be used to track ownership of non-fungible tokens (NFTs). The registry may be centralized or distributed, and in at least some embodiments may be hosted or controlled by at least one trusted entity.

In this example, a user might provide a user environment or virtual experience 222, which in at least some instances may be accessible to others. This might take the form of a virtual museum, such as may be accessible through a virtual metaverse, multiverse, or omniverse, where users can view, access, or virtually interact with various digital art pieces on virtual display in that virtual museum. Such an experience may also take the form of a video game or animation, among other such options. This experience may include views or versions of the 3D model 216 as well as other digital assets, which may be owned by other users or entities in some instances. A user providing the virtual experience 222 may obtain rights or license to display or include these assets in this virtual experience, which may function as a virtual art collection. Since the user providing the experience does not own at least the 3D model 216, the user will need to acquire rights or permission to include a version of the 3D model, and will need to obtain the data for that version that can then be presented in the virtual experience.

In this example, the entire virtual experience 222 might be rendered within a secure environment 210, or at least a version of the 3D model 216 to be included in the virtual experience may be rendered in the secure environment 210, and then transmitted to a server outside the secure environment for rendering a remainder of the virtual experience. In either case, a renderer 214 in the secure environment 210 can be tasked with rendering a lower quality (or otherwise different) version of the 3D model 216 to be presented in the virtual experience. In many instances, a user of the virtual experience 222 will see only a 2D view of any 3D object, such as may be displayed on a monitor. In other instances, the view may be at least somewhat three-dimensional, as may be viewed through a virtual headset with depth capability, but will still be only a partial view of the 3D model from a given point of view. As such, the renderer 214 can use the 3D model 216 in the secure environment 210 to generate an appropriate rendering, such as a 2D rendering 224 to be displayed in the virtual experience 222. In this way, only the rendered pixel data is transmitted outside the secure environment, instead of any graphics calls or version of the model that could be used to reconstruct the 3D model.

In some instances, a user who is interacting with this virtual experience 222 may be able to move (physically or virtually, such as in AR or VR) around the 2D rendering 224 to obtain different views, which may each require a separate rendering to be performed by the renderer 214 in the secure environment. If the viewer moves all the way around the digital asset and obtains a large number of different rendering for different views, the viewer may be able to generate a relatively accurate version of the 3D model by aggregating and processing this image data. Accordingly, there may be limits on the 2D renderings to reduce the accuracy of such an unauthorized reconstruction. For example, the 2D renderings might be limited in resolution, such that any attempted reconstruction would have to perform some type of interpolation or super resolution processing to attempt to generate a high resolution 3D model. Similarly, the size of the rendering, ability of a user to zoom in on the rendering to get more detailed views, or a proximity with which a viewer is able to view the digital asset may be limited, to similarly make it difficult for the viewer to recreate a copy of the 3D model from a series of 2D renderings 224. There may be other modifications made to the 2D rendering to prevent an accurate reconstruction from being made from aggregating pixel data from the provided renderings. In some embodiments, there may also be some restrictions on viewing angle or other such aspects, such as where a virtual statue corresponding to an owned asset may be required to be placed behind a demarcation such as a “virtual rope” along a virtual wall, such that a viewer can only see a front portion of the asset through the 2D renderings, and will be unable to receive data for all views, sides, or portions of the asset.

In some embodiments, a user providing a virtual experience 222 or owner of a secure asset may allow for a user to alter one or more aspects of the 3D model that are used for the 2D renderings 224, while in other embodiments an owner may require at least one modification such that there are no versions of the 3D model that represent a specific view or set of aspects. For example, there may be various textures that can be applied to a 3D model when generating a 2D rendering, and there may be one or more textures that are reserved for the owner and not used to generate 3D renderings. There may also be certain combinations of textures, colors, levels of surface roughness, lighting, poses, or other aspects that are reserved for the owner, or for only certain users. For example, a user obtaining rights to include a version of the 3D model in a virtual experience might obtain rights to provide a view with a certain combination of features, or may be able to select from a different combination of features. When a request is received to generate a 2D rendering 224 for such a virtual experience 222, a request can be received to a content manager 212, such as a server in the secure environment 210, which can check a license database 218 (or other such repository) to determine whether the request is authorized to obtain a rendering of the 3D model, as well as any limitations or options available for the rendering. In some embodiments, this may include referencing a set of parameters in a parameter database 220, or other such location, to determine which parameters may be variable in generating renderings, then comparing those against the rights obtained per the license stored in the license database 218. There may also be a license database 206 outside the secure environment that is available with respect to the user environment or virtual experience 222. In at least some embodiments, a license might be digitally signed by the owner or encrypted using public key cryptography, or the information could potentially be written to the blockchain or stored to a distributed ledger. In some embodiments, the license may indicate aspects such as a right to use a version of an asset for certain purposes, a time for that use, restrictions or permissions on views or aspects, and so on.

A client device 202 in a public environment 208 (or otherwise outside the secure environment 210) may be used by the user to perform tasks such as to check the registry 204 for ownership with respect to a digital asset, obtain or verify license terms using data in a license database 206, then submit an appropriate request to the content manager 212 in the secure environment 210. The content manager 212 can check for rights available corresponding to the request, and can provide relevant information to a renderer 214 to generate the 2D rendering 224 using the 3D model 216 in the secure environment, and provide pixels for that 2D rendering to the client device 202 or directly to a server hosting the virtual environment or a third party client device 228, 230 for one or more users interacting with the virtual experience 222. In some embodiments, a request for a version of the 3D model may need to include some verifiable information, such as credentials, a token, a digital signature, asymmetric encryption, or other verifiable information. In some embodiments, once rights are determined, parameters set, and a 2D rendering 224 provided for a virtual experience 222, updated renderings can be provided without again checking for rights or options in response to movement or changes in the virtual environment. For example, a user might move a virtual avatar or character within the virtual experience 222 to obtain different views of the represented assets, or the experience might have changes in lighting or atmosphere that may impact the renderings. Taking such an approach, digital assets such as 3D NFTs can have their full (3D) descriptions encoded through public-key encryption, and can only be viewed through, for example, secure cloud-rendering streamed (or otherwise transmitted) into web browsers or other client-side applications. A 2D rendering 224 can be provided within such an experience 222, along with potentially other renderings or digital assets 226 as discussed elsewhere herein.

In at least some embodiments, a digital asset such as a 3D model can be generated using procedural generation within the secure environment 210 as illustrated in the system 250 FIG. 2B. Reference numbers may be carried over for similar components between figures for simplicity of explanation and understanding, but such usage should not be interpreted as a limitation on the scope of various examples or embodiments presented herein unless otherwise specifically stated. Further, while 3D models are provided as a primary example, it should be understood that any type of digital asset that can be generated and/or owned can be used with such a system, where the asset may include image, audio, video, text, and/or other such types of content. In one example, a user can use an application or interface running on a client device 202 in a public environment 208 (or otherwise outside the secure environment 210) to call into a content generator 256 hosted using one or more secure resources in the secure environment 210. In at least one embodiment, a call or request can be received to an interface layer 252 that can include interfaces—such as one or more application programming interfaces (APIs)—to receive specific types of requests and direct those requests to the appropriate component, service, process, or recipient, such as where requests to generate a digital asset may be directed to a content generator 256 and requests to obtain content corresponding to an asset that has already been generated, or can be created or obtained based on that already-generated asset, can be directed to a content manager 212 such as that discussed with respect to FIG. 2A.

In one example, one or more requests on a user session can be received to a content generator 256 to generate a digital asset. In order to generate the asset, at least one procedural generator may need to be selected, whether by the user, the content generator, or another such source. This may include, for example, a generative machine learning model or other generative artificial intelligence (AI) component that is appropriate—and appropriately trained—to generate the requested type of asset. The user and/or another source can provide input to the content generator 256 that can be used to generate the digital asset. This input may include, but is not limited to, a text prompt, an image an audio file, spoken instructions, style codes, and reference models, among other such options. The input, along with any other appropriate or necessary input, can be provided to the generative AI component in this example, and output can be received that can correspond to a generated or synthesized digital (or at least partially digital) asset, such as a 3D model. If the user decides to obtain or retain the generated 3D model 216, the generated 3D model 216 can be stored to a 3D model repository and made available to a user or entity having rights to the 3D model, or to obtain content generated from the 3D model, such as was described above with respect to FIG. 2A.

It might be the case that the user not only wants to obtain rights to the generated digital asset—such as the procedurally-generated 3D model—but also at least some rights relating to the generation of that digital asset. For example, this may include rights to the input—such as the text prompt—that was used to generate the digital asset. Information about the input can be stored with information about the generated asset to a registry 260, which may be distributed or centralized. In some embodiments, the information about asset ownership and asset creation may be stored to the same registry, while in other embodiments the information may be stored to separate registries. For example, information about asset ownership might be stored to a registry 204 in a public environment, such as a blockchain, and information about the input used to generate the asset might be stored to a different registry 260, such as a database maintained by a trusted entity in the secure environment. In at least one embodiment, the information stored to the registry may specify or be used to validate the input data, but may not include the input itself. For example, if a user obtains or retains rights to a text prompt that was used to generate an asset then it may be undesirable to include a readable version of the text prompt in an accessible registry as other parties who are not party to the agreement can potentially obtain and use the prompt to generate a similar (or even exact) replica or instance of the generated digital asset. Accordingly, the information used to identify or verify the text prompt, or other such input, can correspond to an encrypted or digitally signed version of the text prompt, such as may be performed using the public key of an asymmetric encryption key pair. In this way, only those people or entities having access to the appropriate private key can decrypt the text prompt stored to the registry. Such an approach enables ownership or rights in particular input to be verifiable without disclosing the actual input to unintended parties.

Rights or ownership obtainable for such input can vary in different embodiments or instances. For example, the user owning the generated asset might also want to obtain ownership of the prompt used to generate the asset so that no one else can replicate the asset using the same, or a similar, procedural generation process. This may include an exact text prompt, for example, or may include any text prompt or input that includes, or is derived from, that text prompt, among other such options. In some embodiments, the user may be granted certain rights in a prompt or input used to generate an asset, but also may not be able to obtain access to the actual input. For example, a user might provide spoken or text input that is then used to generate a prompt that is in a specific format, structure, language, syntax, etc. The user can select to reuse or modify the input, but may not ever see the actual version of the prompt or input that is provided to a generative AI component, for example. A version of, or information able to be used to verify, the input can be stored to a registry, where the information may be encrypted before storage, or a value such as a hash (e.g., a SHA-256 hash) or checksum can be stored to the registry that may not be usable on its own to derive the input, but may be used to verify that specific input is what was used to generate the asset by generating a hash (or checksum, etc.) of the proposed input and then comparing the hash to the value stored in the registry. Any provenance information, such as the version of the model used, the training data used to train that version, the parameters for that version, other inputs used, etc., may be stored to the registry using secret protection in at least one embodiment.

Additional information can be stored as well that can help to define the rights owned by a given entity with respect to an asset, or the ability to generate the same or a similar asset. For example, a user might be given the exclusive rights to a text prompt that was used to generate a digital asset, so that no one else may be able to generate a separate version of that asset, but those rights might be tied to a particular generative process, model, algorithm, or other such generation-related component or aspect. For example, a specific generative AI model might have been used that was trained on one or more specified datasets and had a given set of network weights. The rights to a text prompt might be tied to any or all of that specific data, or class of data, as any variation in those values or components would likely result in a significantly different asset. A user might be able to obtain rights to only those inputs that can be used to recreate the exact asset to which the user has rights, or might have exclusive (or non-exclusive) rights to use specific input with a specific model, or model trained using a specific set (or sets) of training data, etc. If the user has rights to use a model trained using a specific training data set, the user might also need to provide verifiable proof of rights to the training data set as well for at least some sets of training data. Any such information also can be stored to a registry, and the information may be in a format that is appropriate for that registry. For example, if the information is stored in the secure environment 210 then it may be stored to a registry 260 in unencrypted or modified form, or may be stored to a trusted database as a set of hashes (or other values) that can be used to verify that information. For example, a hash can be generated of an executable, training data set, set of network parameters, and so on, and these hash values can be stored to a hash repository 258, secure registry 260, or public registry 204 in hash or encrypted form, etc.

In one or more embodiments, the same input to the same process might result in different assets being generated, such as where generative AI is used that may generate many different outputs for the same input. This might include, for example, many different 3D models for the same input prompt—such as many different models of dog for the same “dog” prompt. In at least one embodiment, a seed can be used to generate the digital asset so that the process is repeatable and the same output will be generated. The user may then retain rights to the seed, or only a text prompt when used in conjunction with that seed, or other options that ensure that the user only obtains a specific digital asset. The information written to the registry can then include information about the seed as well, whether including the seed itself or a hash or secured version of the seed for verification. If a generative AI model—such as a generative adversarial network (GAN) or large language model—uses a random number generator, a seed can be used to ensure that the same random number is used during generation to initialize the random number generator so that the same output will be received, making the generated output exactly reproducible.

In at least some embodiments, a user generating a 3D model (or other digital asset) using such a system or process can retain ownership of that model, as well as versions or views of that model that are to be generated from that model. A user can also enable other parties to obtain models, versions, or views of other digital assets generated using an approach to which that user has retained rights. For example, a user retaining such rights (referred to as an “owner” for this example) can enable another user (referred to as a “buyer”) to use an “owned” text prompt with the process used to generate an original asset, as may be verifiable using the information in a registry 260, with one or more restrictions to ensure differences with respect to the original generated asset, such as to have a lower resolution, smaller size, or reduced color depth. The buyer alternatively may be able to generate a model (or image generated from a new model) generated using a prompt that is based on the original owned prompt, but that has additional information added to the prompt. For example, if the owned text prompt relates to a particular character in a specific outfit performing a specific action, the text prompt may add additional elements or features (such as a hat) to the outfit, or may specify or add something to the prompt to be used to generate the new model, such as to specify that a “ball” being kicked in an original image is a basketball. Various other additional or derivations can be used as well within the scope of the various embodiments. Depending on what is purchased, the buyer can then obtain the new model, rights in the new model, one or more images corresponding to views of that model, or other such assets. The buyer may buy directly from the user, or may use a client device 264 to purchase the rights or assets through an e-commerce site or digital marketplace 262, for example, which may need to contact a client device 202 associated with the owner to obtain the rights or complete the transaction, or may work directly with the content manager 212 in the secure environment to generate and obtain the corresponding asset(s).

As mentioned, the new digital assets generated for the buyer may be generated using a content generator 256 or other such component, process, or service. The prompts, input parameters, or other input, along with information indicating the generative process and components can be verified or determined using the information in a registry 260, for example, without that information ever being exposed outside the secure environment 210, at least in an unsecure form. In some embodiments, a buyer may have information written to a registry that indicates what was generated, how the asset was generated, and the rights that the buyer obtained, but that information may be encrypted or secured as discussed elsewhere herein. In some embodiments the buyer may obtain a shared secret, such as an encryption key, that enables the buyer to determine that information, but in other embodiments the secret may not be shared outside the secure environment so that there is no risk of the secret being inadvertently disclosed by a buyer or other party obtaining access to the secret information.

In at least one embodiment, a buyer purchasing a digital asset through a marketplace may be able to select from a set of options that indicate the rights to be obtained. The available options may be agreed upon in advance by the owner of the original asset, prompt, or other asset or information being used or leveraged to generate the new asset. For example, an owner may own a text prompt that may be used with a specific process to generate a digital asset, where that information is all verifiable through a trusted registry. The buyer may be able to select options such as ownership or an exclusive license to the generated content, ownership or an exclusive license to a specific modification of the text prompt used to generate the asset, specific types of content that may be generated, as well as uses of that content, among other such options. The cost to the buyer may vary based on the options selected and rights obtained. Where exclusive license options are obtained, ownership may remain in the original owner or the provider of the content generator 256, among other such options. Once determined and agreed upon, the information can be written to an appropriate registry to reflect the ownership and/or additional rights or licenses. At least some of this information may be secured or otherwise protected from disclosure but useful for validation.

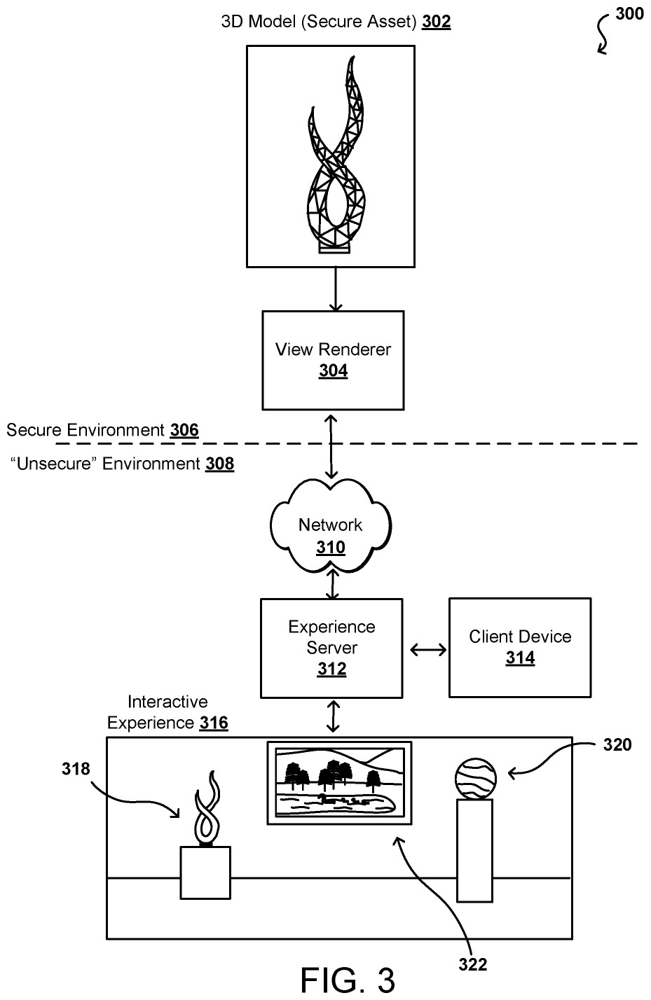

FIG. 3 illustrates components of an example system 300 for providing a representation of a digital asset in an interactive virtual (or augmented or enhanced) reality experience. In this example, an experience provider may be able to provide a virtual experience through a secure environment 306 that can be accessed by various users, applications, devices, or services. As mentioned, this may be a fully virtual reality (VR) experience, such as may be part of a metaverse, omniverse, or multiverse experience. A user may use a client device 314 to obtain at least a portion of this content, which may then be presented via the client device 314, such as through a VR headset. The client device 314 can submit requests for content for the interactive experience 316 to an experience server 312, where those requests can include information such as user input, field of view, and option selection. The experience server 312 can use this information to update a current view of the interactive experience to be provided to the client device 314. In some embodiments, the experience server 312 may provide data for the experience that can be rendered on the client device 314, while in other embodiments at least some of the data will be rendered on the experience server 312 and only image data will be transmitted for display or presentation via the client device 314.

As mentioned, such an interactive experience 316 may be able to include views or representations of digital assets that may not be owned by a provider of the interactive experience. For example, this interactive experience 316 may correspond to a virtual museum or a location that displays a digital art collection. This may include views or representations of digital objects such as sculptures 320 or paintings 322, the inclusion and representation of which can depend, at least in part, upon a current location and field of view of a user (or representation of that user, such as an avatar), in this interactive experience. Depending upon the type of experience and any associated permissions or limitations, the user may be able to view, pick up, or otherwise interact with these digital objects in this interactive experience.

There may be at least one digital object to be represented in the experience that corresponds to an owned unique digital asset, such as is discussed herein. In this example, this representation corresponds to a 2D image 318 view of a 3D model 302 of an art glass piece. This 3D model 302 is a secure digital asset that is stored in a secure environment 306, or at least stored or secured in such a way that the model data is inaccessible to an unauthorized user or entity without the mechanism (e.g., an encryption key) to access that data. If such a 2D view 318 is to be included in the interactive experience 316, then a view renderer 304 in the secure environment 306 can receive information needed to render the appropriate view from the experience server 312, such as may be transmitted across at least one network 310 such as a cellular or wireless network, or the Internet. The view renderer 304 can use the 3D model 302 (including any texture, color, or other relevant data) to render or otherwise generate the appropriate 2D (or 3D/4D) view, and can then transmit only the rendered pixel data outside the secure environment 306 and across the network(s) 310. This pixel data can then be included in the interactive experience 316 in a number of different ways. In one embodiment, the entire interactive experience 316 is rendered by the view renderer 304 (or another such renderer) in the secure environment 306, and then the pixel data for the current view of the interactive experience 316 is transmitted across a network 310 into an “unsecure” environment 308, or other environment outside the secure environment 306, and provided to the experience server 312, which can then provide that data to the client device 314 for presentation. In such a system, the experience server 312 may be used to initiate a session on behalf of the client device, but then the pixel data is streamed from the view renderer 304 to the client device 314. In another embodiment, the pixel data for the 2D view 316 is streamed to the experience server, which can include that image data in the interactive experience that is otherwise rendered at the experience server 312. In such an embodiment, the experience server 312 is enabled to include views or representations of secure assets that may be rendered from different secure environments (or other sources), and incorporate that pixel (or audio, etc.) data into the interactive experience 316, which can be transmitted to the client device. In still other embodiments, the experience server 312 may be responsible for coordinating the data for these various assets, and sending data for the virtual experience 316 to the client device 314, which can then render the interactive experience on the client device 316, where that rendering process includes incorporating the already-rendered pixel (or other) data for the assets to be included. Various other processes for generating and updating an interactive experience 316, which may include already rendered or generated data for various secure assets, may be performed as well within the scope of the various embodiments. As mentioned, the interactive experience may also be presented in various other forms, such as may be provided through a 2D display on a monitor, or an augmented reality (AR) or enhanced reality (ER) experience presented through goggles, smart glasses or contacts, or other such devices, where representations of digital assets can be displayed as a type of overlay over a view of a physical environment, where that overlay is generated with an appearance that corresponds to a current state and view of that physical environment.

In other embodiments, a user or entity may obtain a copy or version of a unique digital asset for various other purposes that are unrelated to virtual experiences. This may include use of the copies for personal enjoyment, such as for a user to view, watch, or listen to at various times. In some embodiments, these copies may be included in products or offerings such as games, movies, or animations, printed in physical books, or used for any of a number of other such purposes. In at least some embodiments, an ability to use these copies for these or other types of activities may be specified, limited, or controlled by terms of a license or agreement under which a user or entity obtains a copy of an owned asset.

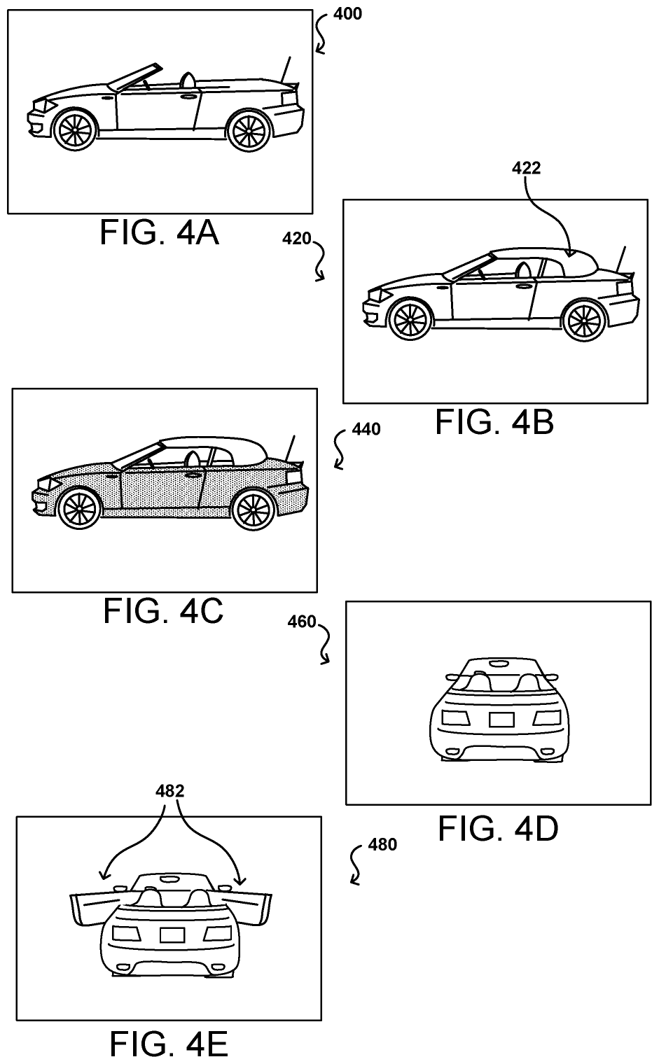

As mentioned, updated renderings of a digital asset can be generated as needed, such as in response to movement or a change in field of view or viewpoint of a user or avatar in a physical or virtual space, or a selection of an option through an application or web interface. Each rendering will be generated in the same secure environment in at least one embodiment, with updated pixel data being transmitted or streamed outside of that secure environment. As discussed elsewhere herein, this data may be encrypted or compressed, or may include only updated pixel data relative to a prior transmission. In at least some embodiments, a user (or experience provider or other authorized entity) may also be able to specify or change one or more aspects of a representation of a digital asset. For example, consider a secure asset or NFT that corresponds to a virtual model of a vehicle, as illustrated in FIGS. 4A-4E. In this example, the vehicle is a convertible automobile. The 3D model of the vehicle may have a parameter that can be specified for rendering, which can include whether to generate a view 400 of the vehicle with the top down, as illustrated in FIG. 4A, or a view 420 of the vehicle with the top 422 up, as illustrated in FIG. 4B. This may be a parameter that corresponds to either state, such that a secure model of this asset can be used to generate either 2D view (or a 3D representation different from the secure 3D model) from the 3D model. In some embodiments, this may be a multi-dimensional model, such as a 4D model that includes behavior information. In such an embodiment, a user may request to obtain a view of vehicle with the top down, as in FIG. 4A, where the view currently has the top 422 up as in FIG. 4B. A sequence of images can then be rendered and transmitted that shows the top 422 being lowered, using a behavior that is indicated by, or stored or otherwise associated with, the model in the secure environment. This behavior may represent a realistic behavior of the model that is unavailable outside the secure environment, such that only view renderings of this behavior are provided as discussed herein.

There may be other parameters for an asset that specify options or aspects that may be able to be modified or specified for a representation to be generated or provided of that asset. In at least one embodiment, this may include a color, pattern, or texture for at least some aspect of an asset. As an example, a rendered view 440 illustrated in FIG. 4C shows the body color of the vehicle in a different color than in the view 420 of FIG. 4B. A user (or other entity) may be able to specify, or change between, any of a number of specified colors, or may be potentially able to request any color for which color data is accessible to a renderer in the secure environment. In other embodiments, a user may be able to obtain a license or otherwise arrange for views of that asset to be provided in a specific color, where only representations provided to that user have that color or other aspect. In this way, that asset having that color (or aspect) will only be viewable in an experience provided by, or associated with, that user. A licensed user may then be able to obtain rights to present representations of an owned asset with a specific aspect, even if the licensed user does not own the asset, and may be able to prevent other users (or even the owner) to provide representations of that asset having that color or aspect, as specified under terms of the license. In some embodiments, a user may be able to add graphics, textures, or other aspects to the representation, but unless these are provided as separate overlays then these aspects are to be provided to a renderer or other component in the secure environment, such that all rendering is still performed in the secure environment with only pixel, view, or representation data being transmitted outside the secure environment. There may be other modifiable aspects as well, as may represent different states or behaviors for open and closed doors 482, as illustrated in the example images 460, 480 of FIGS. 4D and 4E, as well as different lighting states, operational states, and the like. In some embodiments, this asset may be provided as part of a scene that is generated, based at least in part, upon a universal scene description (USD). USD can be used to describe a digital asset using a set of properties and relationships, and allows such a description to be provided in layers that can be used to specify or modify appearance of an asset in a scene asset. In that layer, a user may be able to override one or more of the published properties.

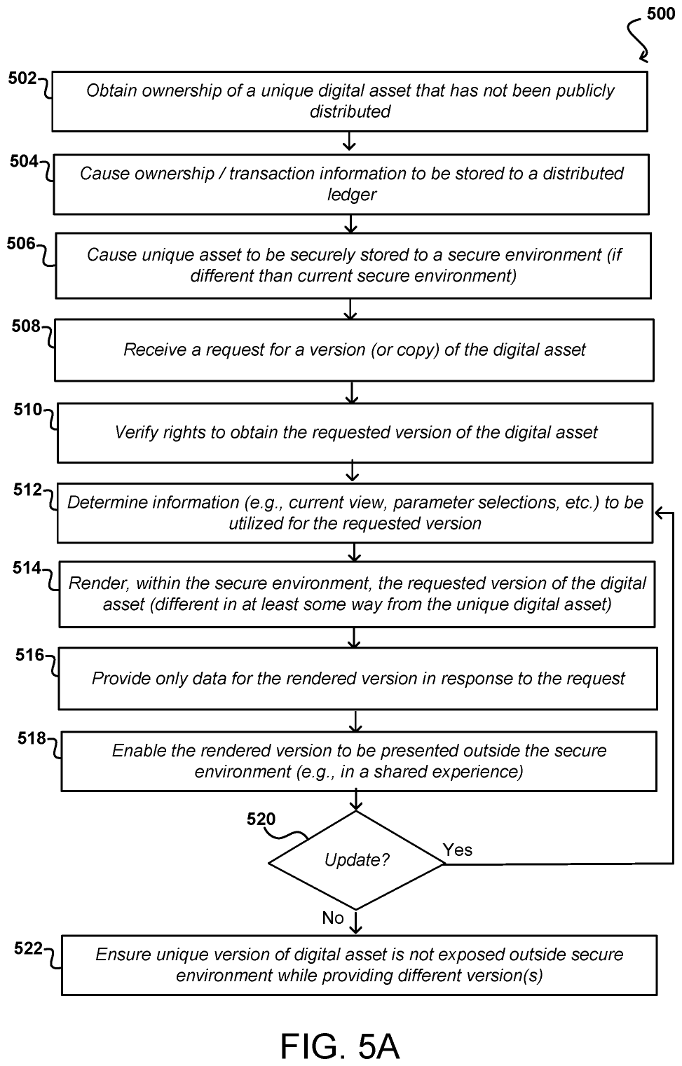

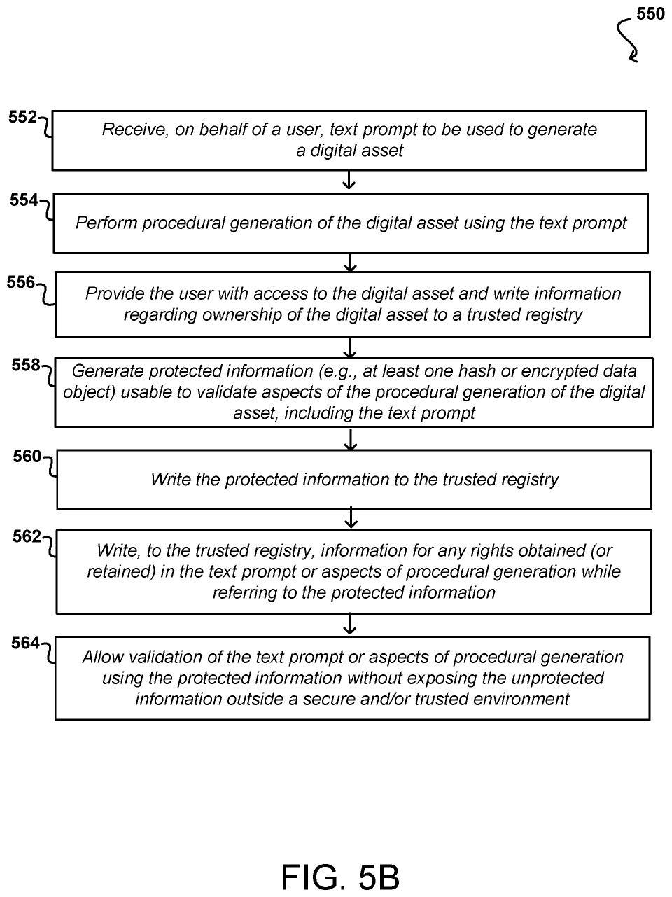

FIG. 5A illustrates an example process 500 to manage ownership and access of a digital asset, which can be used in accordance with various embodiments. In this example, ownership of a unique digital asset is obtained 502, where that unique digital asset has not been publicly distributed or ever available, at least without some type of security applied, outside a secure environment. Ownership can be obtained through a transaction in exchange for compensation, through creation of the unique digital asset itself, or through another such approach. Ownership information, as well as transaction or other relevant information, can be caused 504 to be stored to a distributed ledger, such as a blockchain. In some embodiments, this unique digital asset will take the form of a non-fungible token (NFT). The distributed ledger can take any appropriate form where ownership or transaction information can be securely and verifiably stored, as may also include a secure table or database in a secure location, among other such options. The unique asset can also be caused 506 to be securely stored to a secure environment, if different from a current secure environment in which the asset is stored. If it is necessary to transfer the asset between secure environments, such as from an environment associated with a prior owner or creator to an environment associated with a new owner, then the transmission (or other transfer mechanism) should also be secure in at least some embodiments.

Once a digital asset is securely stored to a secure environment associated with a current owner, that owner may choose whether to allow others to view or obtain versions or copies of that asset. In many embodiments presented herein, an owner will choose to make one or more versions of the digital asset available outside the secure environment, where those versions will differ from the unique digital asset in at least some way. In many embodiments, the owner can dictate these differences, such as by approving specific differences in response to specific requests, or by specifying a set of changeable parameters, with potentially acceptable values for those changeable parameters, among other such options. In this example, a request is received 508 for a version or copy of the digital asset. The request can be received to an owner system or a secure content management service, among other such options as presented and suggested herein. The request may include any appropriate information, as may include information about the requestor, requestor credentials, an indication of the digital asset, an indication of any options or parameter values to be used for the version, and an indication of the intended use for the digital asset. Rights to obtain the requested version of the digital asset can be verified 510, such as by first verifying an identify of a requestor, then verifying that this requestor has obtained or been granted (or should be granted) rights or permission to obtain the requested version, at least for the intended purpose. Information that is to be used to generate the requested version can be determined 512, which can include information from the request as well as information regarding restrictions or permissions for the version, such as maximum resolutions, sizes, zoom levels, and the like. The requested version, at least as permitted per the determined information, can then be rendered 514 (or otherwise generated) within the secure environment. This can include, for example, rendering a 2D image or view from a unique 3D model, where that 2D image or view may have certain determined aspects such as color, texture, size, or resolution. If the rendering is a 2D image generated from a unique 2D image, then the rendered 2D image should differ from the unique 2D image in at least one way or aspect, such as having a lower resolution or color depth. Only the data (e.g., pixel data and any related metadata) for the rendered version can be provided 516 in response to the request, with no other information provided that might potentially enable a recipient (intended or otherwise) to recreate or reconstruct the unique asset. As mentioned, for a 2D image generated from a 3D model, this can include transmitting the pixel data for the rendered image but not any other graphics calls or other information relating to the underlying 3D model that was used to generate the 2D image. The rendered version can be enabled 518 to be presented outside the secure environment, such as in a shared experience, within a scope of use if applicable. In some embodiments, this version may need to be updated over time, such as where a user is moving around the version (physically or virtually) and the rendered view needs to update accordingly for realism. If it is determined 520 that such an update is necessary or appropriate, then the process can continue with information for the updated view or version, which can be rendered or generated in the secure environment and updated version data provided. In either case, it can be ensured 522 that the unique version of the digital asset is not exposed outside the secure environment while providing these different versions (or at least while the asset is to be kept secure). While there may be a potentially unlimited number of versions created within the secure environment, all of the versions will differ from the unique asset in at least some way. There may also be restrictions across all versions, such as all versions being lower resolution or of lower dimension than the unique asset, such that no true or completely accurate reconstruction can be generated by pulling information from the various produced versions.

As mentioned, in at least some embodiments the unique digital asset for which ownership or rights are obtained may be generated using, for example, a procedural generative process. In such embodiments, a user obtaining rights to the generated digital asset may also obtain rights in aspects of the procedural generative process used to generate that digital asset, or information for the process may be written to a registry in order to provide provenance for the generated digital asset, among other such options. FIG. 5B illustrates an example process 550 that may be used to manage additional rights that may be obtainable when a unique digital asset is generated, which may be in addition to the rights and process illustrated and discussed with respect to the example process 500 of FIG. 5A. In this example, a text prompt (or other input) can be received 552 (or otherwise obtained) on behalf of a user that is to be used to generate a digital asset. Procedural generation of the digital asset can then be performed 554 using the digital asset. Aspects of the procedural generation may also be specified by a user, such as to specify a specific version of a generative ML model that was trained on datasets to which the user has a license. The user can be provided 556 with access to the generated digital asset (e.g., under agreed upon access terms), and information regarding ownership or rights in the generated digital asset can be written to a trusted registry. If the user obtained ownership in the digital asset, information indicating that ownership can be written to an appropriate registry.

In this example, the user may also obtain at least some rights in the text prompt or process used to generate that specific asset, or it may be desirable to store information indicating the provenance for the asset, among other potential situations. In some instances, this information may be written to the registry along with the ownership information for the asset. It may be the case, however, that it is preferred not to publicly disclose the information used to generate a unique asset, as then another entity could potentially use that same information to generate an identical (or at least very similar) copy of the asset. Accordingly, in this example process 550, protected information can be generated 558 that is usable to validate aspects of the procedural generation of the digital asset, where the protected information can include the text prompt initially provided and used to generate the asset. The protected information can include one or more hashes generated from that information, or encrypted versions of the information (such as the text prompt), among other such options. The protected information can then also be written 560 to a trusted registry. Information for any rights obtained (or retained) in the generation aspects or text prompt can be written 562 to the trusted registry as well, where that information refers to the protected information written to the registry. In this way, a user retaining rights in the text prompt or the exact aspects of the procedural generative process used to generate the digital asset can have that information written to the registry, without publicly exposing what the text prompt is or which aspects were used. Validation of the text prompt or aspects of procedural generation can be allowed 564, however, using this protected information without exposing the unprotected information outside a trusted environment. For example, a trusted entity having a private key may be able to decrypt the protected information to validate the information. If it is desired to confirm that a specific aspect was used where a hash was used in the protected information, a second hash may be generated for that aspect and compared to the value written to the registry, and if the hash values match exactly then the aspect can be confirmed. Any further assets generated using any or all of this information can have similar information stored to the registry, with updated rights being determinable from the registry as well.

In some embodiments, experiences may be triggered through interactions with a version of an asset. For example, a user “touching” a version of an asset using an avatar may not modify that version, but may trigger other content to be presented, such as fireworks to be displayed or a virtual security alarm to activate. In other embodiments, interaction with a digital asset may trigger an update to that version, such as where a new version will be rendered in the secure environment and the rendered data transmitted for presentation. This could allow, for example, a user to change the pose of a character or open the doors on a virtual vehicle, as discussed with respect to FIGS. 4D and 4E, where the interaction would occur within the virtual experience, but the updated content would be rendered from the secure environment. Such an action can also trigger a behavior that is part of, or associated with, the asset, such as an embedded behavior such as a specific motion, facial expression, or communication. An interaction could also potentially trigger an interaction in the physical world, such as where a user virtually touching a representation of a digital asset can cause a physical version of that asset to be generated, such as through 3D printing, if the license and scope of use allows for such functionality with respect to the asset. In at least one embodiment, this 3D printing would still differ from the unique asset in at least some way, such as being smaller or generated using a lower resolution model.

As discussed, aspects of various approaches presented herein can be lightweight enough to execute on a device such as a client device, such as a personal computer or gaming console, in real time. Such processing can be performed on content (e.g., a rendered version of a unique asset) that is generated on, or received by, that client device or received from an external source, such as streaming sensor data or other content received over at least one network. In some instances, the processing and/or determination of this content may be performed by one of these other devices, systems, or entities, then provided to the client device (or another such recipient) for presentation or another such use.

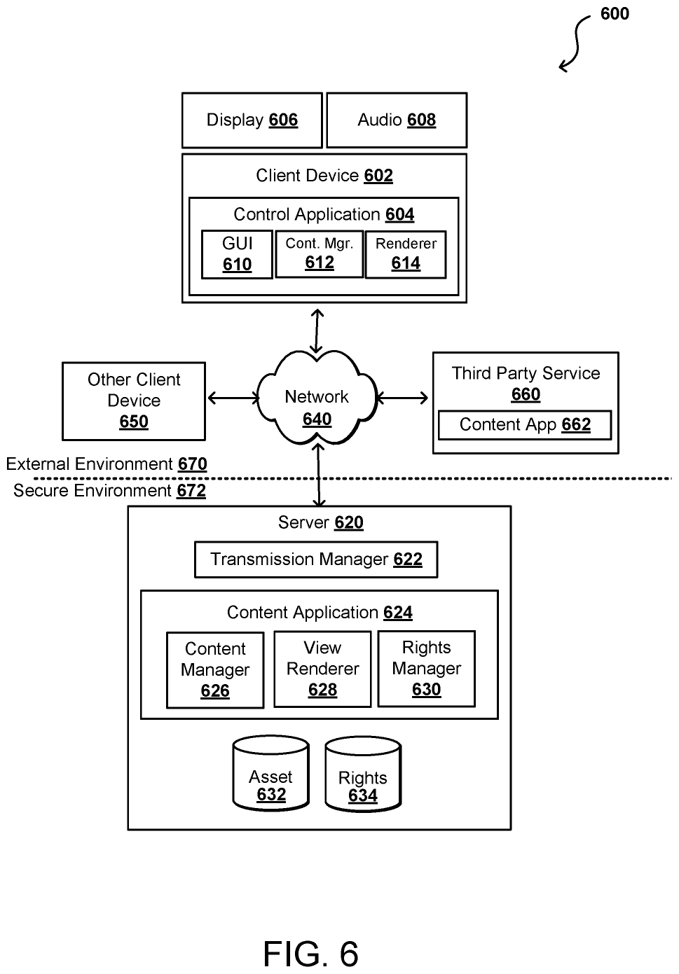

As an example, FIG. 6 illustrates an example network configuration 600 that can be used to provide, generate, modify, encode, and/or transmit data or other such content. In at least one embodiment, a client device 602 can generate or receive data for a session using components of a control application 604 on client device 602 and data stored locally on that client device. In at least one embodiment, a content application 624 executing on a server 620 (e.g., a cloud server or edge server) may initiate a session associated with at least client device 602, as may use a session manager and user data stored in a user database 634, and can cause asset database 632 to be determined by a content manager 626. The server 620 can be located in a secure environment, such that at least some of the content is not exposed in an external environment 670 or otherwise outside that secure environment 672. A content manager 626 may work with a view renderer 628 to generate versions (e.g., 2D images) of assets from a secure asset database 632, to an extent allowable as determined by a rights manager 630 or other such component or service. At least a portion of that generated content (separate and different from the assets themselves) may be transmitted to client device 602 using an appropriate transmission manager 622 to send by download, streaming, or another such transmission channel. An encoder may be used to encode and/or compress at least some of this data before transmitting to the client device 602. In at least one embodiment, client device 602 receiving such content can provide this content to a corresponding control application 604, which may also or alternatively include a graphical user interface 610, content manager 612, and renderer 614 for use in determining representative views. A decoder may also be used to decode data received over the network 640 for presentation via client device 602, such as image or video content through a display 606 and audio, such as sounds and music, through at least one audio playback device 608, such as speakers or headphones. In at least one embodiment, at least some of this content may already be stored on, rendered on, or accessible to client device 602 such that transmission over network 640 is not required for at least that portion of content, such as where that content may have been previously downloaded or stored locally on a hard drive or optical disk. In at least one embodiment, a transmission mechanism such as data streaming can be used to transfer this content from server 620, or user database 634, to client device 602. In at least one embodiment, at least a portion of this content can be obtained or streamed from another source, such as a third party service 660 or other client device 650, that may also include a content application 662 for generating or providing content. In at least one embodiment, portions of this functionality can be performed using multiple computing devices, or multiple processors within one or more computing devices, such as may include a combination of CPUs and GPUs.

In this example, these client devices can include any appropriate computing devices, as may include a desktop computer, notebook computer, set-top box, streaming device, gaming console, smartphone, tablet computer, VR headset, AR goggles, wearable computer, or a smart television. Each client device can submit a request across at least one wired or wireless network, as may include the Internet, an Ethernet, a local area network (LAN), or a cellular network, among other such options. In this example, these requests can be submitted to an address associated with a cloud provider, who may operate or control one or more electronic resources in a cloud provider environment, such as may include a data center or server farm. In at least one embodiment, the request may be received or processed by at least one edge server, that sits on a network edge and is outside at least one security layer associated with the cloud provider environment. In this way, latency can be reduced by enabling the client devices to interact with servers that are in closer proximity, while also improving security of resources in the cloud provider environment.

In at least one embodiment, such a system can be used for performing graphical rendering operations. In other embodiments, such a system can be used for other purposes, such as for providing image or video content to test or validate autonomous machine applications, or for performing deep learning operations. In at least one embodiment, such a system can be implemented using an edge device, or may incorporate one or more Virtual Machines (VMs). In at least one embodiment, such a system can be implemented at least partially in a data center or at least partially using cloud computing resources.

### Inference and Training Logic

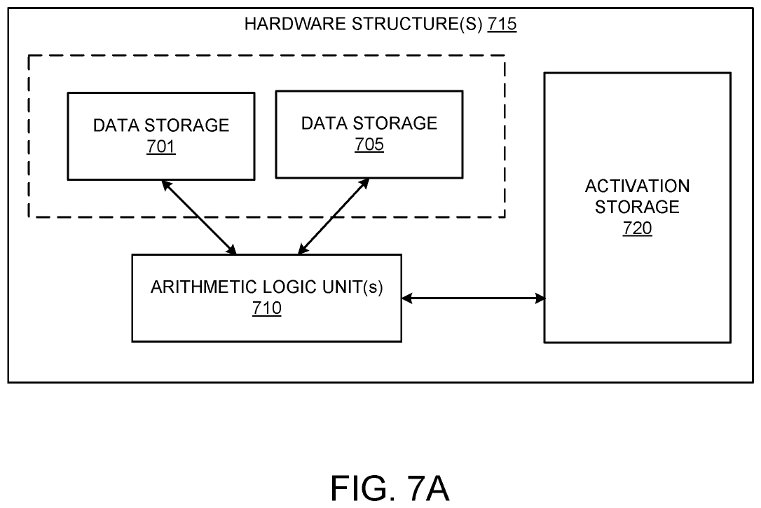

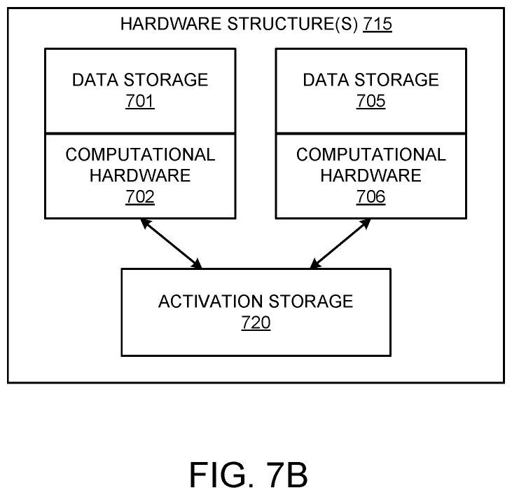

FIG. 7A illustrates inference and/or training logic 715 used to perform inferencing and/or training operations associated with one or more embodiments. Details regarding inference and/or training logic 715 are provided below in conjunction with FIGS. 7A and/or 7B.

In at least one embodiment, inference and/or training logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic 715 may include, or be coupled to code and/or data storage 701 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or data storage 701 may be cache memory, dynamic randomly addressable memory (“DRAM”), static randomly addressable memory (“SRAM”), non-volatile memory (e.g., Flash memory), or other storage. In at least one embodiment, choice of whether code and/or data storage 701 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 715 may include, or be coupled to code and/or data storage 705 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to on one or more processors or other hardware logic devices or circuits. In at least one embodiment, code and/or data storage 705 may be cache memory, DRAM, SRAM, non-volatile memory (e.g., Flash memory), or other storage. In at least one embodiment, choice of whether code and/or data storage 705 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be same storage structure. In at least one embodiment, code and/or data storage 701 and code and/or data storage 705 may be partially same storage structure and partially separate storage structures. In at least one embodiment, any portion of code and/or data storage 701 and code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 701 and/or code and/or data storage 705 are used as operands along with other values, such as bias values, gradient information, momentum values, or other parameters or hyperparameters, any or all of which may be stored in code and/or data storage 701 or code and/or data storage 705 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALUs 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 701, code and/or data storage 705, and activation storage 720 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., Flash memory), or other storage. In at least one embodiment, activation storage 720 may be completely or partially within or external to one or more processors or other logical circuits. In at least one embodiment, choice of whether activation storage 720 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 715 illustrated in FIG. 7A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one or more embodiments. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, result of which is stored in activation storage 720.

In at least one embodiment, each of code and/or data storage 701 and 705 and corresponding computational hardware 702 and 706, respectively, correspond to different layers of a neural network, such that resulting activation from one “storage/computational pair 701/702” of code and/or data storage 701 and computational hardware 702 is provided as an input to “storage/computational pair 705/706” of code and/or data storage 705 and computational hardware 706, in order to mirror conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage computation pairs 701/702 and 705/706 may be included in inference and/or training logic 715.

### Data Center

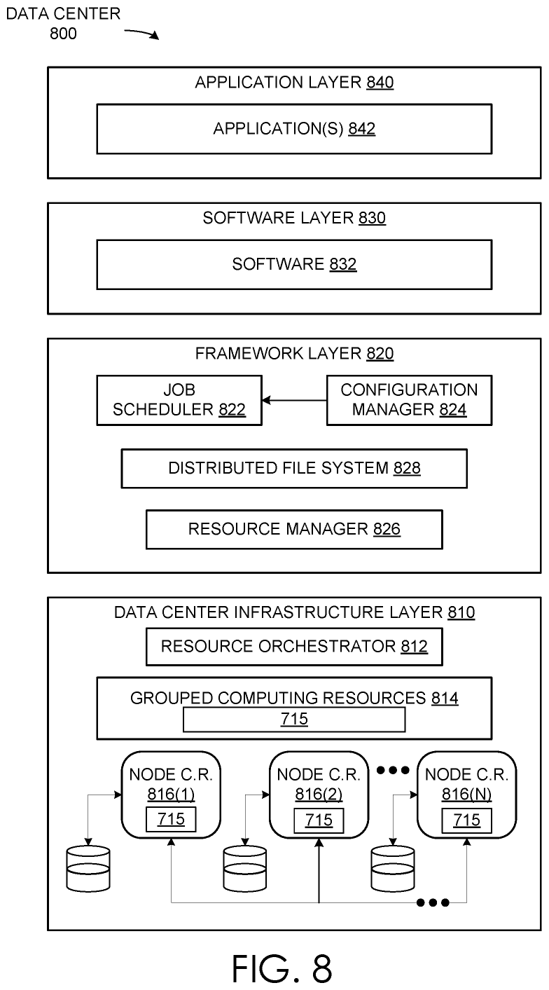

FIG. 8 illustrates an example data center 800, in which at least one embodiment may be used. In at least one embodiment, data center 800 includes a data center infrastructure layer 810, a framework layer 820, a software layer 830, and an application layer 840.

In at least one embodiment, as shown in FIG. 8, data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 816(1)-816(N) may be a server having one or more of above-mentioned computing resources.

In at least one embodiment, grouped computing resources 814 may include separate groupings of node C.R.s housed within one or more racks (not shown), or many racks housed in data centers at various geographical locations (also not shown). Separate groupings of node C.R.s within grouped computing resources 814 may include grouped compute, network, memory or storage resources that may be configured or allocated to support one or more workloads. In at least one embodiment, several node C.R.s including CPUs or processors may be grouped within one or more racks to provide compute resources to support one or more workloads. In at least one embodiment, one or more racks may also include any number of power modules, cooling modules, and network switches, in any combination.

In at least one embodiment, resource orchestrator 812 may configure or otherwise control one or more node C.R.s 816(1)-816(N) and/or grouped computing resources 814. In at least one embodiment, resource orchestrator 812 may include a software design infrastructure (“SDI”) management entity for data center 800. In at least one embodiment, resource orchestrator 812 may include hardware, software or some combination thereof.

In at least one embodiment, as shown in FIG. 8, framework layer 820 includes a job scheduler 822, a configuration manager 824, a resource manager 826 and a distributed file system 828. In at least one embodiment, framework layer 820 may include a framework to support software 832 of software layer 830 and/or one or more application(s) 842 of application layer 840. In at least one embodiment, software 832 or application(s) 842 may respectively include web-based service software or applications, such as those provided by Amazon Web Services, Google Cloud and Microsoft Azure. In at least one embodiment, framework layer 820 may be, but is not limited to, a type of free and open-source software web application framework such as Apache Spark™ (hereinafter “Spark”) that may use distributed file system 828 for large-scale data processing (e.g., “big data”). In at least one embodiment, job scheduler 822 may include a Spark driver to facilitate scheduling of workloads supported by various layers of data center 800. In at least one embodiment, configuration manager 824 may be capable of configuring different layers such as software layer 830 and framework layer 820 including Spark and distributed file system 828 for supporting large-scale data processing. In at least one embodiment, resource manager 826 may be capable of managing clustered or grouped computing resources mapped to or allocated for support of distributed file system 828 and job scheduler 822. In at least one embodiment, clustered or grouped computing resources may include grouped computing resource 814 at data center infrastructure layer 810. In at least one embodiment, resource manager 826 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 828 of framework layer 820. The one or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 828 of framework layer 820. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 824, resource manager 826, and resource orchestrator 812 may implement any number and type of self-modifying actions based on any amount and type of data acquired in any technically feasible fashion. In at least one embodiment, self-modifying actions may relieve a data center operator of data center 800 from making possibly bad configuration decisions and possibly avoiding underused and/or poor performing portions of a data center.

In at least one embodiment, data center 800 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 800. In at least one embodiment, trained machine learning models corresponding to one or more neural networks may be used to infer or predict information using resources described above with respect to data center 800 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 8 for inferencing or predicting operations based, at least in part, on weight parameters calculated using neural network training operations, neural network functions and/or architectures, or neural network use cases described herein.

Such components can be used to manage ownership of, and access to, digital assets

### Computer Systems

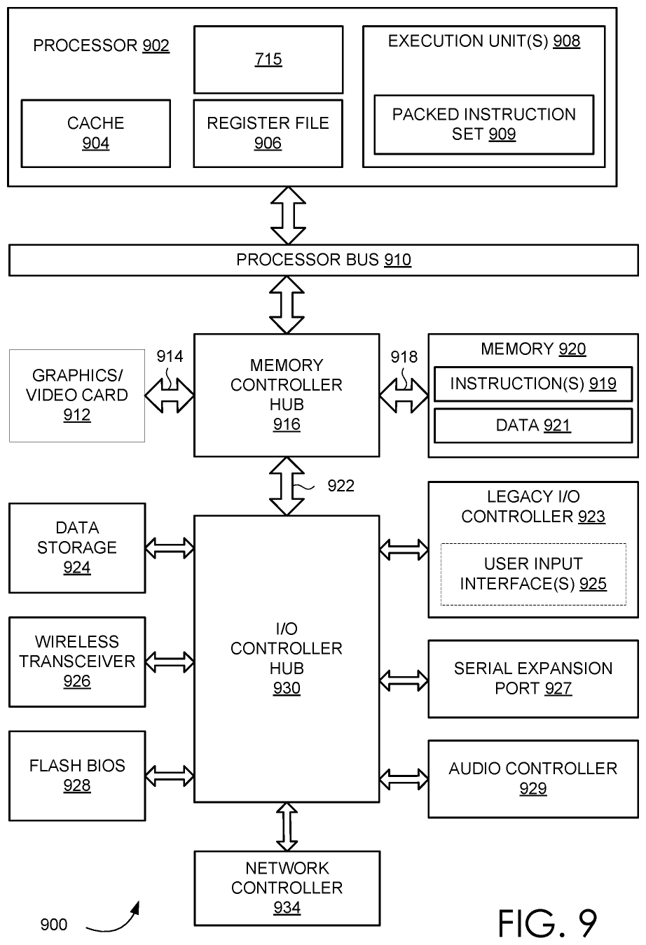

FIG. 9 is a block diagram illustrating an exemplary computer system 900, which may be a system with interconnected devices and components, a system-on-a-chip (SOC) or some combination thereof formed with a processor that may include execution units to execute an instruction, according to at least one embodiment. In at least one embodiment, computer system 900 may include, without limitation, a component, such as a processor 902 to employ execution units including logic to perform algorithms for process data, in accordance with present disclosure, such as in embodiment described herein. In at least one embodiment, computer system 900 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 900 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, computer system 900 may include, without limitation, processor 902 that may include, without limitation, one or more execution unit(s) 908 to perform machine learning model training and/or inferencing according to techniques described herein. In at least one embodiment, computer system 900 is a single processor desktop or server system, but in another embodiment computer system 900 may be a multiprocessor system. In at least one embodiment, processor 902 may include, without limitation, a complex instruction set computing (“CISC”) microprocessor, a reduced instruction set computing (“RISC”) microprocessor, a very long instruction word computing (“VLIW”) microprocessor, a processor implementing a combination of instruction sets, or any other processor device, such as a digital signal processor, for example. In at least one embodiment, processor 902 may be coupled to a processor bus 910 that may transmit data signals between processor 902 and other components in computer system 900.

In at least one embodiment, processor 902 may include, without limitation, a Level 1 (“L1”) internal cache memory (“cache”) 904. In at least one embodiment, processor 902 may have a single internal cache or multiple levels of internal cache. In at least one embodiment, cache 904 may reside external to processor 902. Other embodiments may also include a combination of both internal and external caches depending on particular implementation and needs. In at least one embodiment, register file 906 may store different types of data in various registers including, without limitation, integer registers, floating point registers, status registers, and instruction pointer register.

In at least one embodiment, execution unit(s) 908, including, without limitation, logic to perform integer and floating point operations, also resides in processor 902. In at least one embodiment, processor 902 may also include a microcode (“ucode”) read only memory (“ROM”) that stores microcode for certain macro instructions. In at least one embodiment, execution unit(s) 908 may include logic to handle a packed instruction set 909. In at least one embodiment, by including packed instruction set 909 in an instruction set of a general-purpose processor 902, along with associated circuitry to execute instructions, operations used by many multimedia applications may be performed using packed data in a general-purpose processor 902. In one or more embodiments, many multimedia applications may be accelerated and executed more efficiently by using full width of a processor data bus 910 for performing operations on packed data, which may eliminate need to transfer smaller units of data across processor data bus 910 to perform one or more operations one data element at a time.

In at least one embodiment, execution unit(s) 908 may also be used in microcontrollers, embedded processors, graphics devices, DSPs, and other types of logic circuits. In at least one embodiment, computer system 900 may include, without limitation, a memory 920. In at least one embodiment, memory 920 may be implemented as a Dynamic Random Access Memory (“DRAM”) device, a Static Random Access Memory (“SRAM”) device, flash memory device, or other memory device. In at least one embodiment, memory 920 may store instruction(s) 919 and/or data 921 represented by data signals that may be executed by processor 902.

In at least one embodiment, system logic chip may be coupled to processor bus 910 and memory 920. In at least one embodiment, system logic chip may include, without limitation, a memory controller hub (“MCH”) 916, and processor 902 may communicate with MCH 916 via processor bus 910. In at least one embodiment, MCH 916 may provide a high bandwidth memory path 918 to memory 920 for instruction and data storage and for storage of graphics commands, data and textures. In at least one embodiment, MCH 916 may direct data signals between processor 902, memory 920, and other components in computer system 900 and to bridge data signals between processor bus 910, memory 920, and a system I/O 922. In at least one embodiment, system logic chip may provide a graphics port for coupling to a graphics controller. In at least one embodiment, MCH 916 may be coupled to memory 920 through a high bandwidth memory path 918 and graphics/video card 912 may be coupled to MCH 916 through an Accelerated Graphics Port (“AGP”) interconnect 914.

In at least one embodiment, computer system 900 may use system I/O 922 that is a proprietary hub interface bus to couple MCH 916 to I/O controller hub (“ICH”) 930. In at least one embodiment, ICH 930 may provide direct connections to some I/O devices via a local I/O bus. In at least one embodiment, local I/O bus may include, without limitation, a high-speed I/O bus for connecting peripherals to memory 920, chipset, and processor 902. Examples may include, without limitation, an audio controller 929, a firmware hub (“flash BIOS”) 928, a wireless transceiver 926, a data storage 924, a legacy I/O controller 923 containing user input and keyboard interface(s) 925, a serial expansion port 927, such as Universal Serial Bus (“USB”), and a network controller 934. Data storage 924 may comprise a hard disk drive, a floppy disk drive, a CD-ROM device, a flash memory device, or other mass storage device.

In at least one embodiment, FIG. 9 illustrates a system, which includes interconnected hardware devices or “chips”, whereas in other embodiments, FIG. 9 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 900 are interconnected using compute express link (CXL) interconnects.

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 9 for inferencing or predicting operations based, at least in part, on weight parameters calculated using neural network training operations, neural network functions and/or architectures, or neural network use cases described herein.

Such components can be used to manage ownership of, and access to, digital assets.

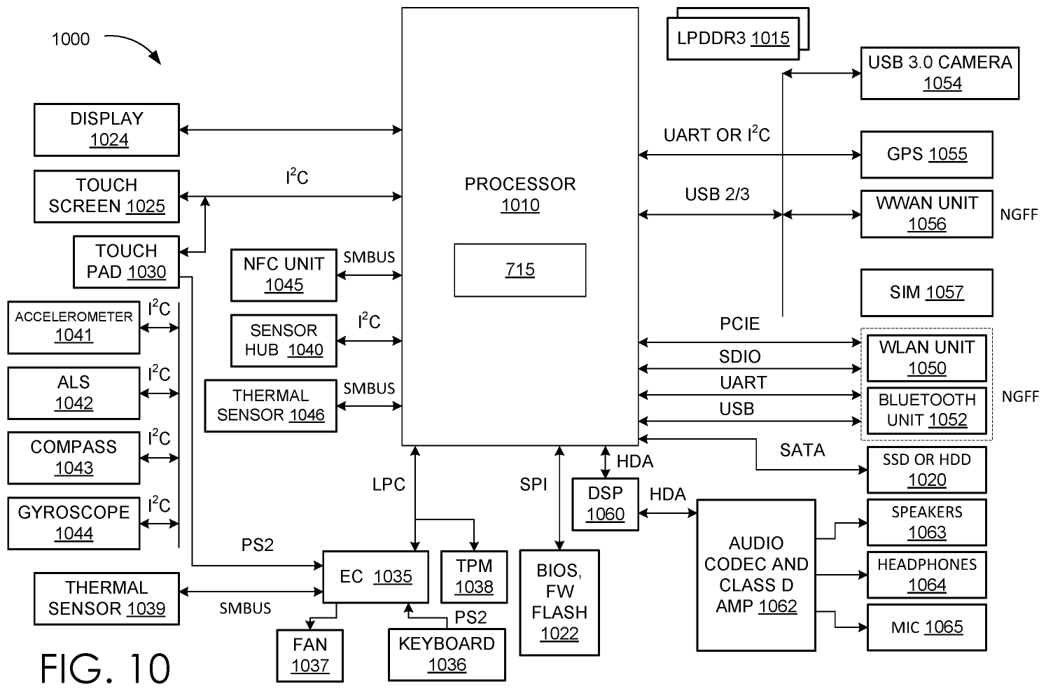

FIG. 10 is a block diagram illustrating an electronic device 1000 for using a processor 1010, according to at least one embodiment. In at least one embodiment, electronic device 1000 may be, for example and without limitation, a notebook, a tower server, a rack server, a blade server, a laptop, a desktop, a tablet, a mobile device, a phone, an embedded computer, or any other suitable electronic device.

In at least one embodiment, electronic device 1000 may include, without limitation, processor 1010 communicatively coupled to any suitable number or kind of components, peripherals, modules, or devices. In at least one embodiment, processor 1010 coupled using a bus or interface, such as a 1° C. bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 10 illustrates a system, which includes interconnected hardware devices or “chips”, whereas in other embodiments, FIG. 10 may illustrate an exemplary System on a Chip (“SoC”). In at least one embodiment, devices illustrated in FIG. 10 may be interconnected with proprietary interconnects, standardized interconnects (e.g., PCIe) or some combination thereof. In at least one embodiment, one or more components of FIG. 10 are interconnected using compute express link (CXL) interconnects.

In at least one embodiment, FIG. 10 may include a display 1024, a touch screen 1025, a touch pad 1030, a Near Field Communications unit (“NFC”) 1045, a sensor hub 1040, a thermal sensor 1046, an Express Chipset (“EC”) 1035, a Trusted Platform Module (“TPM”) 1038, BIOS/firmware/flash memory (“BIOS, FW Flash”) 1022, a DSP 1060, a drive 1020 such as a Solid State Disk (“SSD”) or a Hard Disk Drive (“HDD”), a wireless local area network unit (“WLAN”) 1050, a Bluetooth unit 1052, a Wireless Wide Area Network unit (“WWAN”) 1056, a Global Positioning System (GPS) 1055, a camera (“USB 3.0 camera”) 1054 such as a USB 3.0 camera, and/or a Low Power Double Data Rate (“LPDDR”) memory unit (“LPDDR3”) 1015 implemented in, for example, LPDDR3 standard. These components may each be implemented in any suitable manner.

In at least one embodiment, other components may be communicatively coupled to processor 1010 through components discussed above. In at least one embodiment, an accelerometer 1041, Ambient Light Sensor (“ALS”) 1042, compass 1043, and a gyroscope 1044 may be communicatively coupled to sensor hub 1040. In at least one embodiment, thermal sensor 1039, a fan 1037, a keyboard 1036, and a touch pad 1030 may be communicatively coupled to EC 1035. In at least one embodiment, speakers 1063, headphones 1064, and microphone (“mic”) 1065 may be communicatively coupled to an audio unit (“audio codec and class d amp”) 1062, which may in turn be communicatively coupled to DSP 1060. In at least one embodiment, audio unit 1062 may include, for example and without limitation, an audio coder/decoder (“codec”) and a class D amplifier. In at least one embodiment, SIM card (“SIM”) 1057 may be communicatively coupled to WWAN unit 1056. In at least one embodiment, components such as WLAN unit 1050 and Bluetooth unit 1052, as well as WWAN unit 1056 may be implemented in a Next Generation Form Factor (“NGFF”).

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 10 for inferencing or predicting operations based, at least in part, on weight parameters calculated using neural network training operations, neural network functions and/or architectures, or neural network use cases described herein.

Such components can be used to manage ownership of, and access to, digital assets.

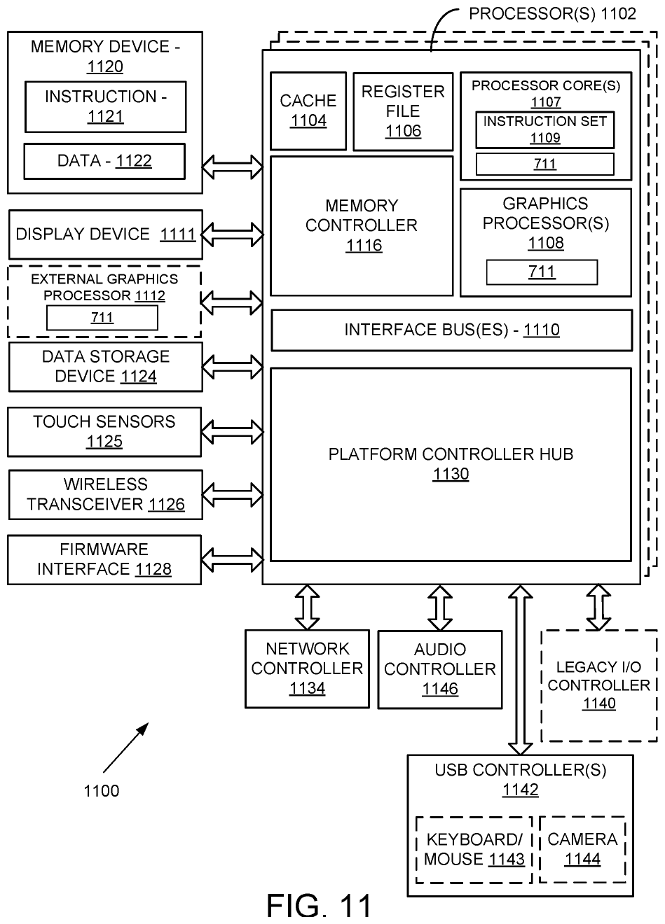

FIG. 11 is a block diagram of a processing system, according to at least one embodiment. In at least one embodiment, processing system 1100 includes one or more processor(s) 1102 and one or more graphics processor(s) 1108, and may be a single processor desktop system, a multiprocessor workstation system, or a server system having a large number of processor(s) 1102 or processor core(s) 1107. In at least one embodiment, processing system 1100 is a processing platform incorporated within a system-on-a-chip (SoC) integrated circuit for use in mobile, handheld, or embedded devices.

In at least one embodiment, processing system 1100 can include, or be incorporated within a server-based gaming platform, a game console, including a game and media console, a mobile gaming console, a handheld game console, or an online game console. In at least one embodiment, processing system 1100 is a mobile phone, smart phone, tablet computing device or mobile Internet device. In at least one embodiment, processing system 1100 can also include, coupled with, or be integrated within a wearable device, such as a smart watch wearable device, smart eyewear device, augmented reality device, or virtual reality device. In at least one embodiment, processing system 1100 is a television or set top box device having one or more processor(s) 1102 and a graphical interface generated by one or more graphics processor(s) 1108.

In at least one embodiment, one or more processor(s) 1102 each include one or more processor core(s) 1107 to process instructions which, when executed, perform operations for system and user software. In at least one embodiment, each of one or more processor core(s) 1107 is configured to process a specific instruction set 1109. In at least one embodiment, instruction set 1109 may facilitate Complex Instruction Set Computing (CISC), Reduced Instruction Set Computing (RISC), or computing via a Very Long Instruction Word (VLIW). In at least one embodiment, processor core(s) 1107 may each process a different instruction set 1109, which may include instructions to facilitate emulation of other instruction sets. In at least one embodiment, processor core(s) 1107 may also include other processing devices, such a Digital Signal Processor (DSP).

In at least one embodiment, processor(s) 1102 includes cache memory (“cache”) 1104. In at least one embodiment, processor(s) 1102 can have a single internal cache or multiple levels of internal cache. In at least one embodiment, cache 1104 is shared among various components of processor(s) 1102. In at least one embodiment, processor(s) 1102 also uses an external cache (e.g., a Level-3 (L3) cache or Last Level Cache (LLC)) (not shown), which may be shared among processor core(s) 1107 using known cache coherency techniques. In at least one embodiment, register file 1106 is additionally included in processor(s) 1102 which may include different types of registers for storing different types of data (e.g., integer registers, floating point registers, status registers, and an instruction pointer register). In at least one embodiment, register file 1106 may include general-purpose registers or other registers.

In at least one embodiment, one or more processor(s) 1102 are coupled with one or more interface bus(es) 1110 to transmit communication signals such as address, data, or control signals between processor(s) 1102 and other components in processing system 1100. In at least one embodiment, interface bus(es) 1110, in one embodiment, can be a processor bus, such as a version of a Direct Media Interface (DMI) bus. In at least one embodiment, interface bus(es) 1110 is not limited to a DMI bus, and may include one or more Peripheral Component Interconnect buses (e.g., PCI, PCI Express), memory buses, or other types of interface buses. In at least one embodiment processor(s) 1102 include an integrated memory controller 1116 and a platform controller hub 1130. In at least one embodiment, memory controller 1116 facilitates communication between a memory device 1120 and other components of processing system 1100, while platform controller hub (PCH) 1130 provides connections to I/O devices via a local I/O bus.

In at least one embodiment, memory device 1120 can be a dynamic random access memory (DRAM) device, a static random access memory (SRAM) device, flash memory device, phase-change memory device, or some other memory device having suitable performance to serve as process memory. In at least one embodiment memory device 1120 can operate as system memory for processing system 1100, to store data 1122 and instructions 1121 for use when one or more processor(s) 1102 executes an application or process. In at least one embodiment, memory controller 1116 also couples with an optional external graphics processor 1112, which may communicate with one or more graphics processor(s) 1108 in processor(s) 1102 to perform graphics and media operations. In at least one embodiment, a display device 1111 can connect to processor(s) 1102. In at least one embodiment display device 1111 can include one or more of an internal display device, as in a mobile electronic device or a laptop device or an external display device attached via a display interface (e.g., DisplayPort, etc.). In at least one embodiment, display device 1111 can include a head mounted display (HMD) such as a stereoscopic display device for use in virtual reality (VR) applications or augmented reality (AR) applications.

In at least one embodiment, platform controller hub 1130 enables peripherals to connect to memory device 1120 and processor(s) 1102 via a high-speed I/O bus. In at least one embodiment, I/O peripherals include, but are not limited to, an audio controller 1146, a network controller 1134, a firmware interface 1128, a wireless transceiver 1126, touch sensors 1125, a data storage device 1124 (e.g., hard disk drive, flash memory, etc.). In at least one embodiment, data storage device 1124 can connect via a storage interface (e.g., SATA) or via a peripheral bus, such as a Peripheral Component Interconnect bus (e.g., PCI, PCI Express). In at least one embodiment, touch sensors 1125 can include touch screen sensors, pressure sensors, or fingerprint sensors. In at least one embodiment, wireless transceiver 1126 can be a Wi-Fi transceiver, a Bluetooth transceiver, or a mobile network transceiver such as a 3G, 4G, or Long Term Evolution (LTE) transceiver. In at least one embodiment, firmware interface 1128 enables communication with system firmware, and can be, for example, a unified extensible firmware interface (UEFI). In at least one embodiment, network controller 1134 can enable a network connection to a wired network. In at least one embodiment, a high-performance network controller (not shown) couples with interface bus(es) 1110. In at least one embodiment, audio controller 1146 is a multi-channel high definition audio controller. In at least one embodiment, processing system 1100 includes an optional legacy I/O controller 1140 for coupling legacy (e.g., Personal System 2 (PS/2)) devices to system. In at least one embodiment, platform controller hub 1130 can also connect to one or more Universal Serial Bus (USB) controller(s) 1142 connect input devices, such as keyboard and mouse 1143 combinations, a camera 1144, or other USB input devices.

In at least one embodiment, an instance of memory controller 1116 and platform controller hub 1130 may be integrated into a discreet external graphics processor, such as external graphics processor 1112. In at least one embodiment, platform controller hub 1130 and/or memory controller 1116 may be external to one or more processor(s) 1102. For example, in at least one embodiment, processing system 1100 can include an external memory controller 1116 and platform controller hub 1130, which may be configured as a memory controller hub and peripheral controller hub within a system chipset that is in communication with processor(s) 1102.

Inference and/or training logic 715 are used to perform inferencing and/or training operations associated with one or more embodiments. Details regarding inference and/or training logic 715 are provided below in conjunction with FIGS. 7A and/or 7B. In at least one embodiment portions or all of inference and/or training logic 715 may be incorporated into processing system 1100. For example, in at least one embodiment, training and/or inferencing techniques described herein may use one or more of ALUs embodied in a graphics processor. Moreover, in at least one embodiment, inferencing and/or training operations described herein may be done using logic other than logic illustrated in FIGS. 7A and/or 7B. In at least one embodiment, weight parameters may be stored in on-chip or off-chip memory and/or registers (shown or not shown) that configure ALUs of a graphics processor to perform one or more machine learning algorithms, neural network architectures, use cases, or training techniques described herein.

Such components can be used to manage ownership of, and access to, digital assets.

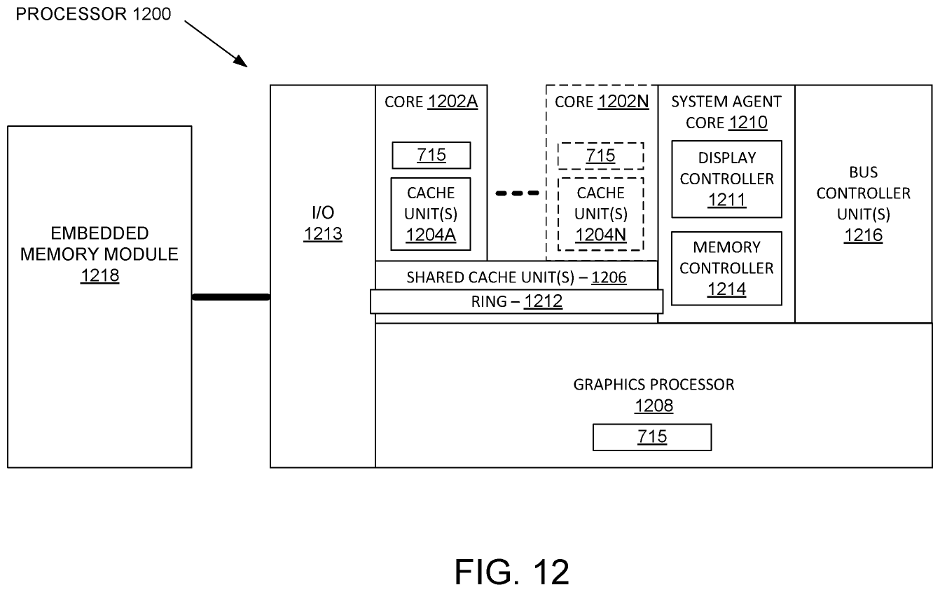

FIG. 12 is a block diagram of a processor 1200 having one or more processor core(s) 1202A-1202N, an integrated memory controller(s) 1214, and an integrated graphics processor 1208, according to at least one embodiment. In at least one embodiment, processor 1200 can include additional cores up to and including additional processor core 1202N represented by dashed lined boxes. In at least one embodiment, each of processor core(s) 1202A-1202N includes one or more internal cache unit(s) 1204A-1204N. In at least one embodiment, each processor core also has access to one or more shared cached unit(s) 1206.

In at least one embodiment, internal cache unit(s) 1204A-1204N and shared cache unit(s) 1206 represent a cache memory hierarchy within processor 1200. In at least one embodiment, internal cache unit(s) 1204A-1204N may include at least one level of instruction and data cache within each processor core and one or more levels of shared mid-level cache, such as a Level 2 (L2), Level 3 (L3), Level 4 (L4), or other levels of cache, where a highest level of cache before external memory is classified as an LLC. In at least one embodiment, cache coherency logic maintains coherency between various shared and internal cache unit(s) 1206 and 1204A-1204N.

In at least one embodiment, processor 1200 may also include a set of one or more bus controller unit(s) 1216 and a system agent core 1210. In at least one embodiment, one or more bus controller unit(s) 1216 manage a set of peripheral buses, such as one or more PCI or PCI express buses. In at least one embodiment, system agent core 1210 provides management functionality for various processor components. In at least one embodiment, system agent core 1210 includes one or more integrated memory controller(s) 1214 to manage access to various external memory devices (not shown).

In at least one embodiment, one or more of processor core(s) 1202A-1202N include support for simultaneous multi-threading. In at least one embodiment, system agent core 1210 includes components for coordinating and operating processor core(s) 1202A-1202N during multi-threaded processing. In at least one embodiment, system agent core 1210 may additionally include a power control unit (PCU), which includes logic and components to regulate one or more power states of processor core(s) 1202A-1202N and graphics processor 1208.

In at least one embodiment, processor 1200 additionally includes graphics processor 1208 to execute graphics processing operations. In at least one embodiment, graphics processor 1208 couples with shared cache unit(s) 1206, and system agent core 1210, including one or more integrated memory controller(s) 1214. In at least one embodiment, system agent core 1210 also includes a display controller 1211 to drive graphics processor output to one or more coupled displays. In at least one embodiment, display controller 1211 may also be a separate module coupled with graphics processor 1208 via at least one interconnect, or may be integrated within graphics processor 1208.

In at least one embodiment, a ring based interconnect unit 1212 is used to couple internal components of processor 1200. In at least one embodiment, an alternative interconnect unit may be used, such as a point-to-point interconnect, a switched interconnect, or other techniques. In at least one embodiment, graphics processor 1208 couples with ring based interconnect unit 1212 via an I/O link 1213.

In at least one embodiment, I/O link 1213 represents at least one of multiple varieties of I/O interconnects, including an on package I/O interconnect which facilitates communication between various processor components and a high-performance embedded memory module 1218, such as an eDRAM module. In at least one embodiment, each of processor core(s) 1202A-1202N and graphics processor 1208 use embedded memory modules 1218 as a shared Last Level Cache.

In at least one embodiment, processor core(s) 1202A-1202N are homogenous cores executing a common instruction set architecture. In at least one embodiment, processor core(s) 1202A-1202N are heterogeneous in terms of instruction set architecture (ISA), where one or more of processor core(s) 1202A-1202N execute a common instruction set, while one or more other cores of processor core(s) 1202A-1202N executes a subset of a common instruction set or a different instruction set. In at least one embodiment, processor core(s) 1202A-1202N are heterogeneous in terms of microarchitecture, where one or more cores having a relatively higher power consumption couple with one or more power cores having a lower power consumption. In at least one embodiment, processor 1200 can be implemented on one or more chips or as an SoC integrated circuit.

Inference and/or training logic 715 are used to perform inferencing and/or training operations associated with one or more embodiments. Details regarding inference and/or training logic 715 are provided below in conjunction with FIGS. 7A and/or 7B. In at least one embodiment portions or all of inference and/or training logic 715 may be incorporated into processor 1200. For example, in at least one embodiment, training and/or inferencing techniques described herein may use one or more of ALUs embodied in graphics processor 1208, processor core(s) 1202A-1202N, or other components in FIG. 12. Moreover, in at least one embodiment, inferencing and/or training operations described herein may be done using logic other than logic illustrated in FIGS. 7A and/or 7B. In at least one embodiment, weight parameters may be stored in on-chip or off-chip memory and/or registers (shown or not shown) that configure ALUs of graphics processor 1200 to perform one or more machine learning algorithms, neural network architectures, use cases, or training techniques described herein.

Such components can be used to manage ownership of, and access to, digital assets.

### Virtualized Computing Platform

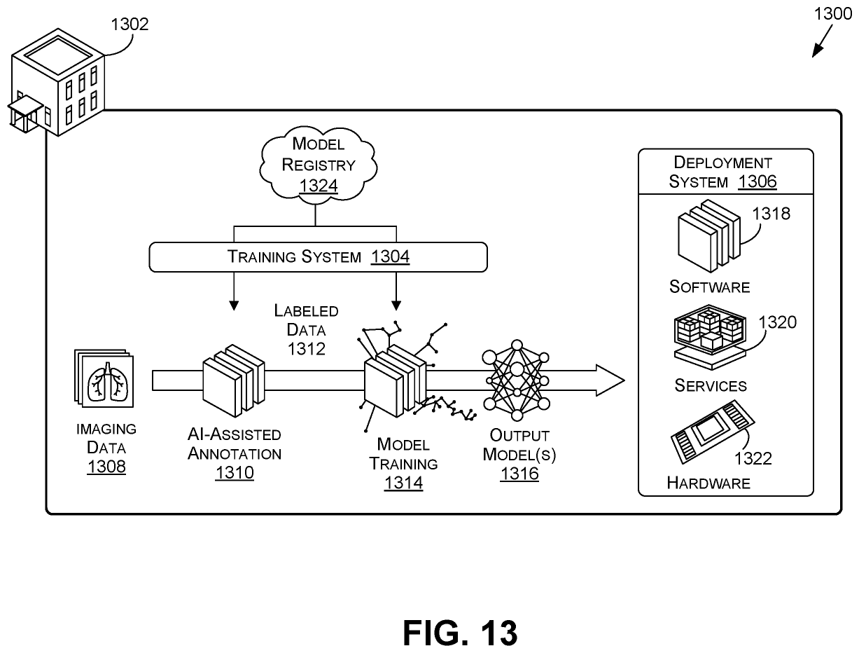

FIG. 13 is an example data flow diagram for a process 1300 of generating and deploying an image processing and inferencing pipeline, in accordance with at least one embodiment. In at least one embodiment, process 1300 may be deployed for use with imaging devices, processing devices, and/or other device types at one or more facility(ies) 1302. Process 1300 may be executed within a training system 1304 and/or a deployment system 1306. In at least one embodiment, training system 1304 may be used to perform training, deployment, and implementation of machine learning models (e.g., neural networks, object detection algorithms, computer vision algorithms, etc.) for use in deployment system 1306. In at least one embodiment, deployment system 1306 may be configured to offload processing and compute resources among a distributed computing environment to reduce infrastructure requirements at facility(ies) 1302. In at least one embodiment, one or more applications in a pipeline may use or call upon services (e.g., inference, visualization, compute, AI, etc.) of deployment system 1306 during execution of applications.

In at least one embodiment, some of applications used in advanced processing and inferencing pipelines may use machine learning models or other AI to perform one or more processing steps. In at least one embodiment, machine learning models may be trained at facility(ies) 1302 using data 1308 (such as imaging data) generated at facility(ies) 1302 (and stored on one or more picture archiving and communication system (PACS) servers at facility(ies) 1302), may be trained using imaging or sequencing data 1308 from another facility(ies), or a combination thereof. In at least one embodiment, training system 1304 may be used to provide applications, services, and/or other resources for generating working, deployable machine learning models for deployment system 1306.

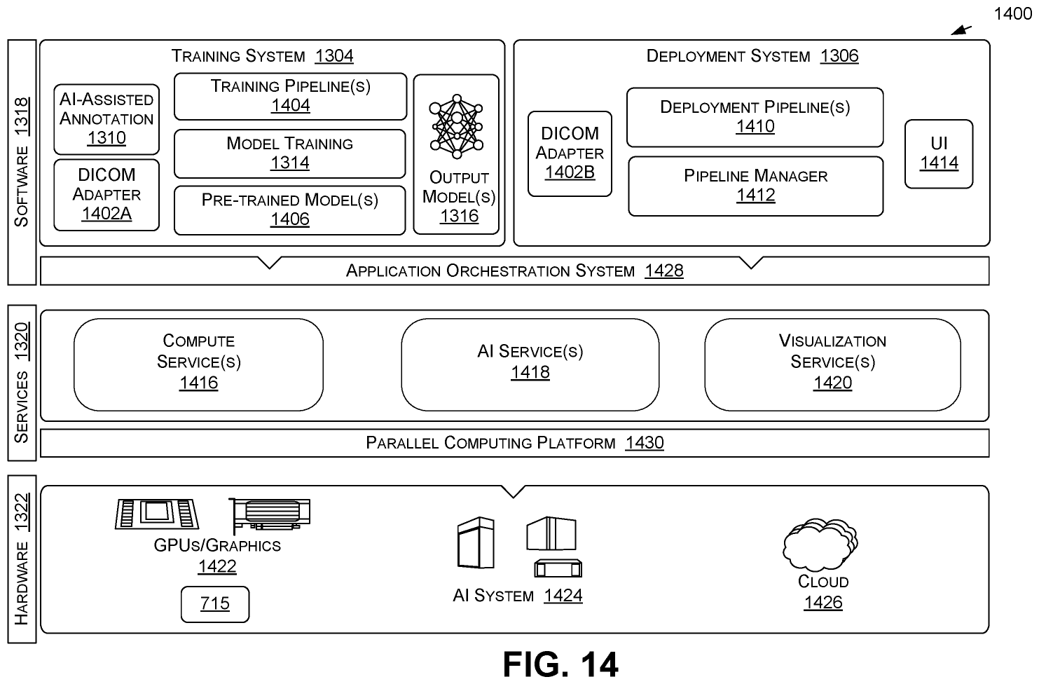

In at least one embodiment, model registry 1324 may be backed by object storage that may support versioning and object metadata. In at least one embodiment, object storage may be accessible through, for example, a cloud storage (e.g., cloud 1426 of FIG. 14) compatible application programming interface (API) from within a cloud platform. In at least one embodiment, machine learning models within model registry 1324 may uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, training pipeline(s) 1404 (FIG. 14) may include a scenario where facility(ies) 1302 is training their own machine learning model, or has an existing machine learning model that needs to be optimized or updated. In at least one embodiment, imaging data 1308 generated by imaging device(s), sequencing devices, and/or other device types may be received. In at least one embodiment, once imaging data 1308 is received, AI-assisted annotation 1310 may be used to aid in generating annotations corresponding to imaging data 1308 to be used as ground truth data for a machine learning model. In at least one embodiment, AI-assisted annotation 1310 may include one or more machine learning models (e.g., convolutional neural networks (CNNs)) that may be trained to generate annotations corresponding to certain types of imaging data 1308 (e.g., from certain devices). In at least one embodiment, AI-assisted annotations 1310 may then be used directly, or may be adjusted or fine-tuned using an annotation tool to generate ground truth data. In at least one embodiment, AI-assisted annotations 1310, labeled data 1312, or a combination thereof may be used as ground truth data for training a machine learning model. In at least one embodiment, a trained machine learning model may be referred to as output model 1316, and may be used by deployment system 1306, as described herein.

In at least one embodiment, training pipeline(s) 1404 (FIG. 14) may include a scenario where facility(ies) 1302 needs a machine learning model for use in performing one or more processing tasks for one or more applications in deployment system 1306, but facility(ies) 1302 may not currently have such a machine learning model (or may not have a model that is optimized, efficient, or effective for such purposes). In at least one embodiment, an existing machine learning model may be selected from a model registry 1324. In at least one embodiment, model registry 1324 may include machine learning models trained to perform a variety of different inference tasks on imaging data. In at least one embodiment, machine learning models in model registry 1324 may have been trained on imaging data from different facilities than facility(ies) 1302 (e.g., facilities remotely located). In at least one embodiment, machine learning models may have been trained on imaging data from one location, two locations, or any number of locations. In at least one embodiment, when being trained on imaging data from a specific location, training may take place at that location, or at least in a manner that protects confidentiality of imaging data or restricts imaging data from being transferred off-premises. In at least one embodiment, once a model is trained—or partially trained—at one location, a machine learning model may be added to model registry 1324. In at least one embodiment, a machine learning model may then be retrained, or updated, at any number of other facilities, and a retrained or updated model may be made available in model registry 1324. In at least one embodiment, a machine learning model may then be selected from model registry 1324—and referred to as output model 1316—and may be used in deployment system 1306 to perform one or more processing tasks for one or more applications of a deployment system.

In at least one embodiment, training pipeline(s) 1404 (FIG. 14), a scenario may include facility(ies) 1302 requiring a machine learning model for use in performing one or more processing tasks for one or more applications in deployment system 1306, but facility(ies) 1302 may not currently have such a machine learning model (or may not have a model that is optimized, efficient, or effective for such purposes). In at least one embodiment, a machine learning model selected from model registry 1324 may not be fine-tuned or optimized for imaging data 1308 generated at facility(ies) 1302 because of differences in populations, robustness of training data used to train a machine learning model, diversity in anomalies of training data, and/or other issues with training data. In at least one embodiment, AI-assisted annotation 1310 may be used to aid in generating annotations corresponding to imaging data 1308 to be used as ground truth data for retraining or updating a machine learning model. In at least one embodiment, labeled data 1312 may be used as ground truth data for training a machine learning model. In at least one embodiment, retraining or updating a machine learning model may be referred to as model training 1314. In at least one embodiment, model training 1314—e.g., AI-assisted annotations 1310, labeled data 1312, or a combination thereof—may be used as ground truth data for retraining or updating a machine learning model. In at least one embodiment, a trained machine learning model may be referred to as output model 1316, and may be used by deployment system 1306, as described herein.

In at least one embodiment, deployment system 1306 may include software 1318, services 1320, hardware 1322, and/or other components, features, and functionality. In at least one embodiment, deployment system 1306 may include a software “stack,” such that software 1318 may be built on top of services 1320 and may use services 1320 to perform some or all of processing tasks, and services 1320 and software 1318 may be built on top of hardware 1322 and use hardware 1322 to execute processing, storage, and/or other compute tasks of deployment system 1306. In at least one embodiment, software 1318 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, an advanced processing and inferencing pipeline may be defined based on selections of different containers that are desired or required for processing imaging data 1308, in addition to containers that receive and configure imaging data for use by each container and/or for use by facility(ies) 1302 after processing through a pipeline (e.g., to convert outputs back to a usable data type). In at least one embodiment, a combination of containers within software 1318 (e.g., that make up a pipeline) may be referred to as a virtual instrument (as described in more detail herein), and a virtual instrument may leverage services 1320 and hardware 1322 to execute some or all processing tasks of applications instantiated in containers.

In at least one embodiment, a data processing pipeline may receive input data (e.g., imaging data 1308) in a specific format in response to an inference request (e.g., a request from a user of deployment system 1306). In at least one embodiment, input data may be representative of one or more images, video, and/or other data representations generated by one or more imaging devices. In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output models 1316 of training system 1304.

In at least one embodiment, tasks of data processing pipeline may be encapsulated in a container(s) that each represents a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 1324 and associated with one or more applications. In at least one embodiment, images of applications (e.g., container images) may be available in a container registry, and once selected by a user from a container registry for deployment in a pipeline, an image may be used to generate a container for an instantiation of an application for use by a user's system.

In at least one embodiment, developers (e.g., software developers, clinicians, doctors, etc.) may develop, publish, and store applications (e.g., as containers) for performing image processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 1320 as a system (e.g., system 1400 of FIG. 14). In at least one embodiment, because DICOM objects may contain anywhere from one to hundreds of images or other data types, and due to a variation in data, a developer may be responsible for managing (e.g., setting constructs for, building pre-processing into an application, etc.) extraction and preparation of incoming data. In at least one embodiment, once validated by system 1400 (e.g., for accuracy), an application may be available in a container registry for selection and/or implementation by a user to perform one or more processing tasks with respect to data at a facility (e.g., a second facility) of a user.

In at least one embodiment, developers may then share applications or containers through a network for access and use by users of a system (e.g., system 1400 of FIG. 14). In at least one embodiment, completed and validated applications or containers may be stored in a container registry and associated machine learning models may be stored in model registry 1324. In at least one embodiment, a requesting entity-who provides an inference or image processing request—may browse a container registry and/or model registry 1324 for an application, container, dataset, machine learning model, etc., select a desired combination of elements for inclusion in data processing pipeline, and submit an imaging processing request. In at least one embodiment, a request may include input data (and associated patient data, in some examples) that is necessary to perform a request, and/or may include a selection of application(s) and/or machine learning models to be executed in processing a request. In at least one embodiment, a request may then be passed to one or more components of deployment system 1306 (e.g., a cloud) to perform processing of data processing pipeline. In at least one embodiment, processing by deployment system 1306 may include referencing selected elements (e.g., applications, containers, models, etc.) from a container registry and/or model registry 1324. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 1320 may be leveraged. In at least one embodiment, services 1320 may include compute services, artificial intelligence (AI) services, visualization services, and/or other service types. In at least one embodiment, services 1320 may provide functionality that is common to one or more applications in software 1318, so functionality may be abstracted to a service that may be called upon or leveraged by applications. In at least one embodiment, functionality provided by services 1320 may run dynamically and more efficiently, while also scaling well by allowing applications to process data in parallel (e.g., using a parallel computing platform 1430 (FIG. 14)). In at least one embodiment, rather than each application that shares a same functionality offered by services 1320 being required to have a respective instance of services 1320, services 1320 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities. In at least one embodiment, a data augmentation service may further be included that may provide GPU accelerated data (e.g., DICOM, RIS, CIS, REST compliant, RPC, raw, etc.) extraction, resizing, scaling, and/or other augmentation. In at least one embodiment, a visualization service may be used that may add image rendering effects-such as ray-tracing, rasterization, denoising, sharpening, etc.—to add realism to two-dimensional (2D) and/or three-dimensional (3D) models. In at least one embodiment, virtual instrument services may be included that provide for beam-forming, segmentation, inferencing, imaging, and/or support for other applications within pipelines of virtual instruments.

In at least one embodiment, where services 1320 includes an AI service (e.g., an inference service), one or more machine learning models may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 1318 implementing advanced processing and inferencing pipeline that includes segmentation application and anomaly detection application may be streamlined because each application may call upon a same inference service to perform one or more inferencing tasks.

In at least one embodiment, hardware 1322 may include GPUs, CPUs, graphics cards, an AI/deep learning system (e.g., an AI supercomputer, such as NVIDIA's DGX), a cloud platform, or a combination thereof. In at least one embodiment, different types of hardware 1322 may be used to provide efficient, purpose-built support for software 1318 and services 1320 in deployment system 1306. In at least one embodiment, use of GPU processing may be implemented for processing locally (e.g., at facility(ies) 1302), within an AI/deep learning system, in a cloud system, and/or in other processing components of deployment system 1306 to improve efficiency, accuracy, and efficacy of image processing and generation. In at least one embodiment, software 1318 and/or services 1320 may be optimized for GPU processing with respect to deep learning, machine learning, and/or high-performance computing, as non-limiting examples. In at least one embodiment, at least some of computing environment of deployment system 1306 and/or training system 1304 may be executed in a datacenter one or more supercomputers or high performance computing systems, with GPU optimized software (e.g., hardware and software combination of NVIDIA's DGX System). In at least one embodiment, hardware 1322 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC) may be executed using an AI/deep learning supercomputer(s) and/or GPU-optimized software (e.g., as provided on NVIDIA's DGX Systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 14 is a system diagram for an example system 1400 for generating and deploying an imaging deployment pipeline, in accordance with at least one embodiment. In at least one embodiment, system 1400 may be used to implement process 1300 of FIG. 13 and/or other processes including advanced processing and inferencing pipelines. In at least one embodiment, system 1400 may include training system 1304 and deployment system 1306. In at least one embodiment, training system 1304 and deployment system 1306 may be implemented using software 1318, services 1320, and/or hardware 1322, as described herein.

In at least one embodiment, system 1400 (e.g., training system 1304 and/or deployment system 1306) may implemented in a cloud computing environment (e.g., using cloud 1426). In at least one embodiment, system 1400 may be implemented locally with respect to a healthcare services facility, or as a combination of both cloud and local computing resources. In at least one embodiment, access to APIs in cloud 1426 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1400, may be restricted to a set of public IPs that have been vetted or authorized for interaction.

In at least one embodiment, various components of system 1400 may communicate between and among one another using any of a variety of different network types, including but not limited to local area networks (LANs) and/or wide area networks (WANs) via wired and/or wireless communication protocols. In at least one embodiment, communication between facilities and components of system 1400 (e.g., for transmitting inference requests, for receiving results of inference requests, etc.) may be communicated over data bus(ses), wireless data protocols (Wi-Fi), wired data protocols (e.g., Ethernet), etc.

In at least one embodiment, training system 1304 may execute training pipeline(s) 1404, similar to those described herein with respect to FIG. 13. In at least one embodiment, where one or more machine learning models are to be used in deployment pipelines 1410 by deployment system 1306, training pipeline(s) 1404 may be used to train or retrain one or more (e.g. pre-trained) models, and/or implement one or more of pre-trained model(s) 1406 (e.g., without a need for retraining or updating). In at least one embodiment, as a result of training pipeline(s) 1404, output model(s) 1316 may be generated. In at least one embodiment, training pipeline(s) 1404 may include any number of processing steps, such as but not limited to imaging data (or other input data) conversion or adaption In at least one embodiment, for different machine learning models used by deployment system 1306, different training pipeline(s) 1404 may be used. In at least one embodiment, training pipeline(s) 1404 similar to a first example described with respect to FIG. 13 may be used for a first machine learning model, training pipeline(s) 1404 similar to a second example described with respect to FIG. 13 may be used for a second machine learning model, and training pipeline(s) 1404 similar to a third example described with respect to FIG. 13 may be used for a third machine learning model. In at least one embodiment, any combination of tasks within training system 1304 may be used depending on what is required for each respective machine learning model. In at least one embodiment, one or more of machine learning models may already be trained and ready for deployment so machine learning models may not undergo any processing by training system 1304, and may be implemented by deployment system 1306.

In at least one embodiment, output model(s) 1316 and/or pre-trained model(s) 1406 may include any types of machine learning models depending on implementation or embodiment. In at least one embodiment, and without limitation, machine learning models used by system 1400 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Hopfield, Boltzmann, deep belief, deconvolutional, generative adversarial, liquid state machine, etc.), and/or other types of machine learning models.

In at least one embodiment, training pipeline(s) 1404 may include AI-assisted annotation 1310, as described in more detail herein with respect to at least FIG. 14. In at least one embodiment, labeled data 1312 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of imaging data 1308 (or other data type used by machine learning models), there may be corresponding ground truth data generated by training system 1304. In at least one embodiment, AI-assisted annotation 1310 may be performed as part of deployment pipeline(s) 1410; either in addition to, or in lieu of AI-assisted annotation 1310 included in training pipeline(s) 1404. In at least one embodiment, system 1400 may include a multi-layer platform that may include a software layer (e.g., software 1318) of diagnostic applications (or other application types) that may perform one or more medical imaging and diagnostic functions. In at least one embodiment, system 1400 may be communicatively coupled to (e.g., via encrypted links) PACS server networks of one or more facilities. In at least one embodiment, system 1400 may be configured to access and referenced data from PACS servers to perform operations, such as training machine learning models, deploying machine learning models, image processing, inferencing, and/or other operations.

In at least one embodiment, a software layer may be implemented as a secure, encrypted, and/or authenticated API through which applications or containers may be invoked (e.g., called) from an external environment(s) (e.g., facility(ies) 1302). In at least one embodiment, applications may then call or execute one or more services 1320 for performing compute, AI, or visualization tasks associated with respective applications, and software 1318 and/or services 1320 may leverage hardware 1322 to perform processing tasks in an effective and efficient manner. In at least one embodiment, communications sent to, or received by, a training system 1304 and a deployment system 1306 may occur using a pair of DICOM adapters 1402A, 1402B.

In at least one embodiment, deployment system 1306 may execute deployment pipeline(s) 1410. In at least one embodiment, deployment pipeline(s) 1410 may include any number of applications that may be sequentially, non-sequentially, or otherwise applied to imaging data (and/or other data types) generated by imaging devices, sequencing devices, genomics devices, etc.—including AI-assisted annotation, as described above. In at least one embodiment, as described herein, deployment pipeline(s) 1410 for an individual device may be referred to as a virtual instrument for a device (e.g., a virtual ultrasound instrument, a virtual CT scan instrument, a virtual sequencing instrument, etc.). In at least one embodiment, for a single device, there may be more than one deployment pipeline(s) 1410 depending on information desired from data generated by a device. In at least one embodiment, where detections of anomalies are desired from an MRI machine, there may be a first deployment pipeline(s) 1410, and where image enhancement is desired from output of an MRI machine, there may be a second deployment pipeline(s) 1410.

In at least one embodiment, an image generation application may include a processing task that includes use of a machine learning model. In at least one embodiment, a user may desire to use their own machine learning model, or to select a machine learning model from model registry 1324. In at least one embodiment, a user may implement their own machine learning model or select a machine learning model for inclusion in an application for performing a processing task. In at least one embodiment, applications may be selectable and customizable, and by defining constructs of applications, deployment and implementation of applications for a particular user are presented as a more seamless user experience. In at least one embodiment, by leveraging other features of system 1400—such as services 1320 and hardware 1322—deployment pipeline(s) 1410 may be even more user friendly, provide for easier integration, and produce more accurate, efficient, and timely results.

In at least one embodiment, deployment system 1306 may include a user interface (“UI”) 1414 (e.g., a graphical user interface, a web interface, etc.) that may be used to select applications for inclusion in deployment pipeline(s) 1410, arrange applications, modify or change applications or parameters or constructs thereof, use and interact with deployment pipeline(s) 1410 during set-up and/or deployment, and/or to otherwise interact with deployment system 1306. In at least one embodiment, although not illustrated with respect to training system 1304, UI 1414 (or a different user interface) may be used for selecting models for use in deployment system 1306, for selecting models for training, or retraining, in training system 1304, and/or for otherwise interacting with training system 1304.

In at least one embodiment, pipeline manager 1412 may be used, in addition to an application orchestration system 1428, to manage interaction between applications or containers of deployment pipeline(s) 1410 and services 1320 and/or hardware 1322. In at least one embodiment, pipeline manager 1412 may be configured to facilitate interactions from application to application, from application to services 1320, and/or from application or service to hardware 1322. In at least one embodiment, although illustrated as included in software 1318, this is not intended to be limiting, and in some examples (e.g., as illustrated in FIG. 12cc) pipeline manager 1412 may be included in services 1320. In at least one embodiment, application orchestration system 1428 (e.g., Kubernetes, DOCKER, etc.) may include a container orchestration system that may group applications into containers as logical units for coordination, management, scaling, and deployment. In at least one embodiment, by associating applications from deployment pipeline(s) 1410 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of another application(s) or container(s). In at least one embodiment, communication, and cooperation between different containers or applications may be aided by pipeline manager 1412 and application orchestration system 1428. In at least one embodiment, so long as an expected input and/or output of each container or application is known by a system (e.g., based on constructs of applications or containers), application orchestration system 1428 and/or pipeline manager 1412 may facilitate communication among and between, and sharing of resources among and between, each of applications or containers. In at least one embodiment, because one or more of applications or containers in deployment pipeline(s) 1410 may share same services and resources, application orchestration system 1428 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, a scheduler may thus allocate resources to different applications and distribute resources between and among applications in view of requirements and availability of a system. In some examples, a scheduler (and/or other component of application orchestration system 1428) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 1320 leveraged by and shared by applications or containers in deployment system 1306 may include compute service(s) 1416, AI service(s) 1418, visualization service(s) 1420, and/or other service types. In at least one embodiment, applications may call (e.g., execute) one or more of services 1320 to perform processing operations for an application. In at least one embodiment, compute service(s) 1416 may be leveraged by applications to perform super-computing or other high-performance computing (HPC) tasks. In at least one embodiment, compute service(s) 1416 may be leveraged to perform parallel processing (e.g., using a parallel computing platform 1430) for processing data through one or more of applications and/or one or more tasks of a single application, substantially simultaneously. In at least one embodiment, parallel computing platform 1430 (e.g., NVIDIA's CUDA) may enable general purpose computing on GPUs (GPGPU) (e.g., GPUs/Graphics 1422). In at least one embodiment, a software layer of parallel computing platform 1430 may provide access to virtual instruction sets and parallel computational elements of GPUs, for execution of compute kernels. In at least one embodiment, parallel computing platform 1430 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1430 (e.g., where multiple different stages of an application or multiple applications are processing same information). In at least one embodiment, rather than making a copy of data and moving data to different locations in memory (e.g., a read/write operation), same data in same location of a memory may be used for any number of processing tasks (e.g., at a same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI service(s) 1418 may be leveraged to perform inferencing services for executing machine learning model(s) associated with applications (e.g., tasked with performing one or more processing tasks of an application). In at least one embodiment, AI service(s) 1418 may leverage AI system 1424 to execute machine learning model(s) (e.g., neural networks, such as CNNs) for segmentation, reconstruction, object detection, feature detection, classification, and/or other inferencing tasks. In at least one embodiment, applications of deployment pipeline(s) 1410 may use one or more of output model(s) 1316 from training system 1304 and/or other models of applications to perform inference on imaging data. In at least one embodiment, two or more examples of inferencing using application orchestration system 1428 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1428 may distribute resources (e.g., services 1320 and/or hardware 1322) based on priority paths for different inferencing tasks of AI service(s) 1418.

In at least one embodiment, shared storage may be mounted to AI service(s) 1418 within system 1400. In at least one embodiment, shared storage may operate as a cache (or other storage device type) and may be used to process inference requests from applications. In at least one embodiment, when an inference request is submitted, a request may be received by a set of API instances of deployment system 1306, and one or more instances may be selected (e.g., for best fit, for load balancing, etc.) to process a request. In at least one embodiment, to process a request, a request may be entered into a database, a machine learning model may be located from model registry 1324 if not already in a cache, a validation step may ensure appropriate machine learning model is loaded into a cache (e.g., shared storage), and/or a copy of a model may be saved to a cache. In at least one embodiment, a scheduler (e.g., of pipeline manager 1412) may be used to launch an application that is referenced in a request if an application is not already running or if there are not enough instances of an application. In at least one embodiment, if an inference server is not already launched to execute a model, an inference server may be launched. Any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as inference server is running as a different instance.

In at least one embodiment, during application execution, an inference request for a given application may be received, and a container (e.g., hosting an instance of an inference server) may be loaded (if not already), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (TAT <1 min) priority while others may have lower priority (e.g., TAT <10 min). In at least one embodiment, model execution times may be measured from requesting institution or entity and may include partner network traversal time, as well as execution on an inference service.

In at least one embodiment, transfer of requests between services 1320 and inference applications may be hidden behind a software development kit (SDK), and robust transport may be provide through a queue. In at least one embodiment, a request will be placed in a queue via an API for an individual application/tenant ID combination and an SDK will pull a request from a queue and give a request to an application. In at least one embodiment, a name of a queue may be provided in an environment from where an SDK will pick it up. In at least one embodiment, asynchronous communication through a queue may be useful as it may allow any instance of an application to pick up work as it becomes available. Results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1426, and an inference service may perform inferencing on a GPU.

In at least one embodiment, visualization service(s) 1420 may be leveraged to generate visualizations for viewing outputs of applications and/or deployment pipeline(s) 1410. In at least one embodiment, GPUs/Graphics 1422 may be leveraged by visualization service(s) 1420 to generate visualizations. In at least one embodiment, rendering effects, such as ray-tracing, may be implemented by visualization service(s) 1420 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization service(s) 1420 may include an internal visualizer, cinematics, and/or other rendering or image processing capabilities or functionality (e.g., ray tracing, rasterization, internal optics, etc.).

In at least one embodiment, hardware 1322 may include GPUs/Graphics 1422, AI system 1424, cloud 1426, and/or any other hardware used for executing training system 1304 and/or deployment system 1306. In at least one embodiment, GPUs/Graphics 1422 (e.g., NVIDIA's TESLA and/or QUADRO GPUs) may include any number of GPUs that may be used for executing processing tasks of compute service(s) 1416, AI service(s) 1418, visualization service(s) 1420, other services, and/or any of features or functionality of software 1318. For example, with respect to AI service(s) 1418, GPUs/Graphics 1422 may be used to perform pre-processing on imaging data (or other data types used by machine learning models), post-processing on outputs of machine learning models, and/or to perform inferencing (e.g., to execute machine learning models). In at least one embodiment, cloud 1426, AI system 1424, and/or other components of system 1400 may use GPUs/Graphics 1422. In at least one embodiment, cloud 1426 may include a GPU-optimized platform for deep learning tasks. In at least one embodiment, AI system 1424 may use GPUs, and cloud 1426—or at least a portion tasked with deep learning or inferencing—may be executed using one or more AI systems 1424. As such, although hardware 1322 is illustrated as discrete components, this is not intended to be limiting, and any components of hardware 1322 may be combined with, or leveraged by, any other components of hardware 1322.

In at least one embodiment, AI system 1424 may include a purpose-built computing system (e.g., a super-computer or an HPC) configured for inferencing, deep learning, machine learning, and/or other artificial intelligence tasks. In at least one embodiment, AI system 1424 (e.g., NVIDIA's DGX) may include GPU-optimized software (e.g., a software stack) that may be executed using a plurality of GPUs/Graphics 1422, in addition to CPUs, RAM, storage, and/or other components, features, or functionality. In at least one embodiment, one or more AI systems 1424 may be implemented in cloud 1426 (e.g., in a data center) for performing some or all of AI-based processing tasks of system 1400.

In at least one embodiment, cloud 1426 may include a GPU-accelerated infrastructure (e.g., NVIDIA's NGC) that may provide a GPU-optimized platform for executing processing tasks of system 1400. In at least one embodiment, cloud 1426 may include an AI system(s) 1424 for performing one or more of AI-based tasks of system 1400 (e.g., as a hardware abstraction and scaling platform). In at least one embodiment, cloud 1426 may integrate with application orchestration system 1428 leveraging multiple GPUs to enable seamless scaling and load balancing between and among applications and services 1320. In at least one embodiment, cloud 1426 may tasked with executing at least some of services 1320 of system 1400, including compute service(s) 1416, AI service(s) 1418, and/or visualization service(s) 1420, as described herein. In at least one embodiment, cloud 1426 may perform small and large batch inference (e.g., executing NVIDIA's TENSOR RT), provide an accelerated parallel computing API and platform 1430 (e.g., NVIDIA's CUDA), execute application orchestration system 1428 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1400.

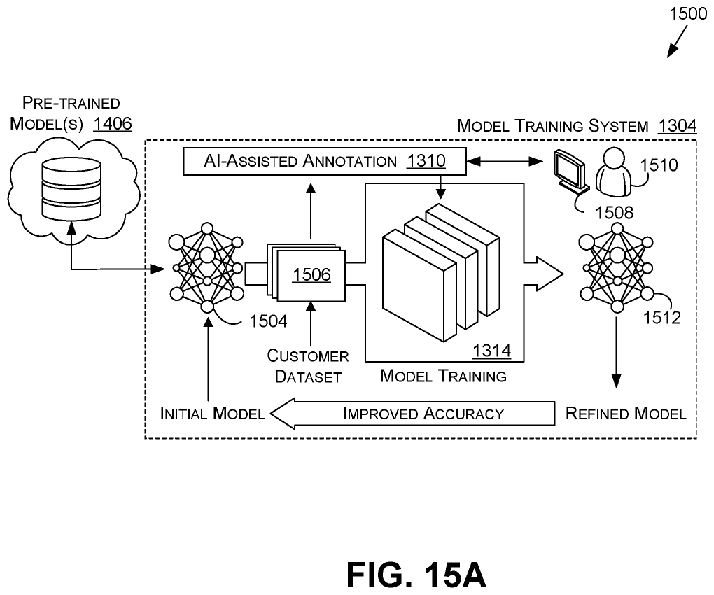

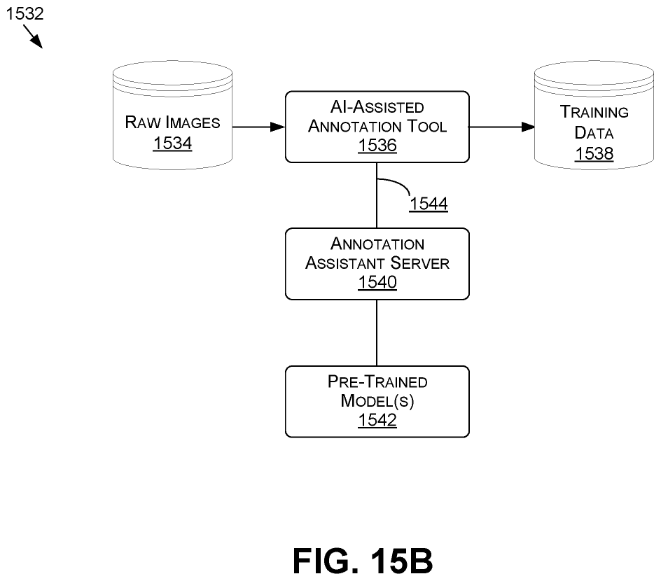

FIG. 15A illustrates a data flow diagram for a process 1500 to train, retrain, or update a machine learning model, in accordance with at least one embodiment. In at least one embodiment, process 1500 may be executed using, as a non-limiting example, system 1400 of FIG. 14. In at least one embodiment, process 1500 may leverage services 1320 and/or hardware 1322 of system 1400, as described herein. In at least one embodiment, refined model 1512 generated by process 1500 may be executed by deployment system 1306 for one or more containerized applications in deployment pipeline(s) 1410.

In at least one embodiment, model training 1314 may include retraining or updating an initial model 1504 (e.g., a pre-trained model) using new training data (e.g., new input data, such as customer dataset 1506, and/or new ground truth data associated with input data). In at least one embodiment, to retrain, or update, initial model 1504, output or loss layer(s) of initial model 1504 may be reset, deleted, and/or replaced with an updated or new output or loss layer(s). In at least one embodiment, initial model 1504 may have previously fine-tuned parameters (e.g., weights and/or biases) that remain from prior training, so training or retraining may not take as long or require as much processing as training a model from scratch. In at least one embodiment, during model training 1314, by having reset or replaced output or loss layer(s) of initial model 1504, parameters may be updated and re-tuned for a new data set based on loss calculations associated with accuracy of output or loss layer(s) at generating predictions on new, customer dataset 1506.

In at least one embodiment, pre-trained model(s) 1406 may be stored in a data store, or registry. In at least one embodiment, pre-trained model(s) 1406 may have been trained, at least in part, at one or more facilities other than a facility executing process 1500. In at least one embodiment, to protect privacy and rights of patients, subjects, or clients of different facilities, pre-trained model(s) 1406 may have been trained, on-premise, using customer or patient data generated on-premise. In at least one embodiment, pre-trained model(s) 1406 may be trained using cloud 1426 and/or other hardware 1322, but confidential, privacy protected patient data may not be transferred to, used by, or accessible to any components of cloud 1426 (or other off premise hardware). In at least one embodiment, where pre-trained model(s) 1406 is trained at using patient data from more than one facility, pre-trained model(s) 1406 may have been individually trained for each facility prior to being trained on patient or customer data from another facility. In at least one embodiment, such as where a customer or patient data has been released of privacy concerns (e.g., by waiver, for experimental use, etc.), or where a customer or patient data is included in a public data set, a customer or patient data from any number of facilities may be used to train pre-trained model(s) 1406 on-premise and/or off premise, such as in a datacenter or other cloud computing infrastructure.

In at least one embodiment, when selecting applications for use in deployment pipelines 1410, a user may also select machine learning models to be used for specific applications. In at least one embodiment, a user may not have a model for use, so a user may select pre-trained model(s) 1406 to use with an application. In at least one embodiment, pre-trained model(s) 1406 may not be optimized for generating accurate results on customer dataset 1506 of a facility of a user (e.g., based on patient diversity, demographics, types of medical imaging devices used, etc.). In at least one embodiment, prior to deploying pre-trained model(s) 1406 into deployment pipeline 1410 for use with an application(s), pre-trained model(s) 1406 may be updated, retrained, and/or fine-tuned for use at a respective facility.

In at least one embodiment, a user may select pre-trained model(s) 1406 that is to be updated, retrained, and/or fine-tuned, and pre-trained model(s) 1406 may be referred to as initial model 1504 for model training system 1304 within process 1500. In at least one embodiment, customer dataset 1506 (e.g., imaging data, genomics data, sequencing data, or other data types generated by devices at a facility) may be used to perform model training 1314 (which may include, without limitation, transfer learning) on initial model 1504 to generate refined model 1512. In at least one embodiment, ground truth data corresponding to customer dataset 1506 may be generated by model training system 1304. In at least one embodiment, ground truth data may be generated, at least in part, by clinicians, scientists, doctors, practitioners, at a facility.

In at least one embodiment, AI-assisted annotation 1310 may be used in some examples to generate ground truth data. In at least one embodiment, AI-assisted annotation 1310 (e.g., implemented using an AI-assisted annotation SDK) may leverage machine learning models (e.g., neural networks) to generate suggested or predicted ground truth data for a customer dataset. In at least one embodiment, user 1510 may use annotation tools within a user interface (a graphical user interface (GUI)) on computing device 1508.

In at least one embodiment, user 1510 may interact with a GUI via computing device 1508 to edit or fine-tune (auto) annotations. In at least one embodiment, a polygon editing feature may be used to move vertices of a polygon to more accurate or fine-tuned locations.

In at least one embodiment, once customer dataset 1506 has associated ground truth data, ground truth data (e.g., from AI-assisted annotation, manual labeling, etc.) may be used by during model training 1314 to generate refined model 1512. In at least one embodiment, customer dataset 1506 may be applied to initial model 1504 any number of times, and ground truth data may be used to update parameters of initial model 1504 until an acceptable level of accuracy is attained for refined model 1512. In at least one embodiment, once refined model 1512 is generated, refined model 1512 may be deployed within one or more deployment pipelines 1410 at a facility for performing one or more processing tasks with respect to medical imaging data.

In at least one embodiment, refined model 1512 may be uploaded to pre-trained model(s) 1406 in model registry 1324 to be selected by another facility. In at least one embodiment, this process may be completed at any number of facilities such that refined model 1512 may be further refined on new datasets any number of times to generate a more universal model.

FIG. 15B is an example illustration of a client-server architecture 1532 to enhance annotation tools with pre-trained model(s) 1542, in accordance with at least one embodiment. In at least one embodiment, AI-assisted annotation tools 1536 may be instantiated based on a client-server architecture 1532. In at least one embodiment, AI-assisted annotation tool 1536 in imaging applications may aid radiologists, for example, identify organs and abnormalities. In at least one embodiment, imaging applications may include software tools that help user 1510 to identify, as a non-limiting example, a few extreme points on a particular organ of interest in raw images 1534 (e.g., in a 3D MRI or CT scan) and receive auto-annotated results for all 2D slices of a particular organ. In at least one embodiment, results may be stored in a data store as training data 1538 and used as (for example and without limitation) ground truth data for training. In at least one embodiment, when computing device 1508 sends extreme points for AI-assisted annotation 1310, a deep learning model, for example, may receive this data as input and return inference results of a segmented organ or abnormality. In at least one embodiment, pre-instantiated annotation tools, such as AI-assisted annotation tool 1536 in FIG. 15B, may be enhanced by making API calls (e.g., API Call 1544) to a server, such as an annotation assistant server 1540 that may include a set of pre-trained models 1542 stored in an annotation model registry, for example. In at least one embodiment, an annotation model registry may store pre-trained model(s) 1542 (e.g., machine learning models, such as deep learning models) that are pre-trained to perform AI-assisted annotation 1310 on a particular organ or abnormality. These models may be further updated by using training pipeline(s) 1404. In at least one embodiment, pre-installed annotation tools may be improved over time as new labeled data is added.

Such components can be used to manage ownership of, and access to, digital assets.

Embodiments disclosed herein may be further described using the following clauses:

1. A method, comprising:
obtaining data representative of a digital asset generated using procedural generation;
determining ownership of the digital asset;
indicating the ownership of the digital asset in a verifiable registry;
writing, to the verifiable registry, information specifying one or more aspects of the procedural generation used to generate the digital asset;
storing the digital asset to a secure environment;
receiving a request for an instance of the digital asset;
rendering, from within the secure environment, the instance of the digital asset including at least one difference with respect to the digital asset; and
providing the instance, in response to the request, for use outside the secure environment.

2. The method of clause 1, wherein the verifiable registry is at least one of a trusted database or a blockchain.

3. The method of clause 1, wherein the digital asset is a three-dimensional (3D) model, and wherein the instance is a two-dimensional (2D) image illustrating a view of the 3D model.

4. The method of clause 1, wherein the digital asset is generated based in part on a prompt provided as input, and wherein the prompt and ownership information for the prompt are stored using the verifiable registry.

5. The method of clause 4, wherein at least one of the prompt or the information specifying one or more aspects of the procedural generation are stored using the verifiable registry in a protected form that allows for validation without public exposure.

6. The method of clause 4, further comprising providing, to an entity, one or more rights to use the prompt with additional input to generate a variation of the digital asset, wherein the providing does not include providing an unprotected version of the prompt to the entity.

7. The method of clause 4, wherein a seed is provided with the prompt to ensure consistent generation of the digital asset using the one or more aspects of the procedural generation, and wherein a protected version of the seed is stored using the verifiable registry.

8. The method of clause 1, wherein the digital asset is not exposed outside the secure environment during the period of ownership and was not previously exposed in an unsecure location.

9. The method of clause 1, wherein the digital asset has associated behavior information, and further comprising:
rendering, from within the secure environment, a sequence of instances of the digital asset representing performance of the associated behavior information.

10. A method, comprising:
obtaining ownership information corresponding to a digital asset;
indicating, based at least on the ownership information, ownership of the digital asset in a verifiable registry;
causing the digital asset to be stored to a secure environment;
receiving a request for content representing the digital asset;
causing the content, representing the digital asset, to be generated from within the secure environment, the generated content being lower in quality than the digital asset for at least one quality metric; and
providing the generated content in response to the request for use outside the secure environment.

11. The method of clause 10, wherein no content is generated to represent the digital asset that has equivalent quality values, for a set of quality metrics including the at least one quality metric, to the digital asset.

12. The method of clause 10, wherein the digital asset is an image, an audio file, a three-dimensional (3D) model, an animation, or a behavior.

13. The method of clause 10, wherein the digital asset has a set of modifiable properties, and wherein the request for the content is enabled to indicate one or more values for one or more of the modifiable properties to be used to generate the content.

14. The method of clause 10, wherein the digital asset is generated using procedural generation, and wherein information indicating one or more aspect of the procedural generation is written to the verifiable registry.

15. The method of clause 10, wherein the at least one quality metric includes at least one of a resolution, a color depth, a size, a bit depth, a bit rate, a dimension, or an amount of compression.

16. The method of clause 10, wherein the digital asset is not exposed outside the secure environment during the period of ownership and was not previously exposed in an unsecure location.

17. A system, comprising:
a processor; and
memory including instructions that, when performed by the processor, cause the system to:
   obtain ownership information corresponding to a three-dimensional (3D) model;
   indicate, based at least on the ownership information, ownership of the 3D model in a verifiable registry;
   store the 3D model to a secure environment;
   receive a request for an image corresponding to a view of the 3D model;
   render, from within the secure environment, the image corresponding to the 3D model; and
   provide the image, in response to the request, for use outside the secure environment.

18. The system of clause 17, wherein the 3D model is generated using procedural generation, and wherein information indicating one or more aspects of the procedural generation is stored using the verifiable ledger.

19. The system of clause 18, wherein the information indicating one or more aspects of the procedural generation are stored using the verifiable ledger in protected form, the protected form allowing validation without public exposure.

20. The system of clause 17, wherein the system comprises at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a system for performing generative AI operations using a large language model (LLM),
a collaborative content creation platform for 3D assets; or
a system implemented at least partially using cloud computing resources.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method, comprising:
obtaining data representative of a digital asset generated using procedural generation;
determining ownership of the digital asset;
indicating the ownership of the digital asset in a verifiable registry;
writing, to the verifiable registry, information specifying one or more aspects of the procedural generation used to generate the digital asset;
storing the digital asset to a secure environment;
receiving a request for an instance of the digital asset;
rendering, from within the secure environment, the instance of the digital asset including at least one difference with respect to the digital asset; and
providing the instance, in response to the request, for use outside the secure environment.

2. The method of claim 1, wherein the verifiable registry is at least one of a trusted database or a blockchain.

3. The method of claim 1, wherein the digital asset is a three-dimensional (3D) model, and wherein the instance is a two-dimensional (2D) image illustrating a view of the 3D model.

4. The method of claim 1, wherein the digital asset is generated based in part on a prompt provided as input, and wherein the prompt and ownership information for the prompt are stored using the verifiable registry.

5. The method of claim 4, wherein at least one of the prompt or the information specifying one or more aspects of the procedural generation are stored using the verifiable registry in a protected form that allows for validation without public exposure.

6. The method of claim 4, further comprising providing, to an entity, one or more rights to use the prompt with additional input to generate a variation of the digital asset, wherein the providing does not include providing an unprotected version of the prompt to the entity.

7. The method of claim 4, wherein a seed is provided with the prompt to ensure consistent generation of the digital asset using the one or more aspects of the procedural generation, and wherein a protected version of the seed is stored using the verifiable registry.

8. The method of claim 1, wherein the digital asset is not exposed outside the secure environment during the period of ownership and was not previously exposed in an unsecure location.

9. The method of claim 1, wherein the digital asset has associated behavior information, and further comprising:
rendering, from within the secure environment, a sequence of instances of the digital asset representing performance of the associated behavior information.

10. A method, comprising:
obtaining ownership information corresponding to a digital asset;
indicating, based at least on the ownership information, ownership of the digital asset in a verifiable registry;
causing the digital asset to be stored to a secure environment;
receiving a request for content representing the digital asset;
causing the content, representing the digital asset, to be generated from within the secure environment, the generated content being lower in quality than the digital asset for at least one quality metric; and
providing the generated content in response to the request for use outside the secure environment.

11. The method of claim 10, wherein no content is generated to represent the digital asset that has equivalent quality values, for a set of quality metrics including the at least one quality metric, to the digital asset.

12. The method of claim 10, wherein the digital asset is an image, an audio file, a three-dimensional (3D) model, an animation, or a behavior.

13. The method of claim 10, wherein the digital asset has a set of modifiable properties, and wherein the request for the content is enabled to indicate one or more values for one or more of the modifiable properties to be used to generate the content.

14. The method of claim 10, wherein the digital asset is generated using procedural generation, and wherein information indicating one or more aspect of the procedural generation is written to the verifiable registry.

15. The method of claim 10, wherein the at least one quality metric includes at least one of a resolution, a color depth, a size, a bit depth, a bit rate, a dimension, or an amount of compression.

16. The method of claim 10, wherein the digital asset is not exposed outside the secure environment during the period of ownership and was not previously exposed in an unsecure location.

17. A system, comprising:
a processor; and
memory including instructions that, when performed by the processor, cause the system to:
obtain ownership information corresponding to a three-dimensional (3D) model;
indicate, based at least on the ownership information, ownership of the 3D model in a verifiable registry;
store the 3D model to a secure environment;
receive a request for an image corresponding to a view of the 3D model;
render, from within the secure environment, the image corresponding to the 3D model; and
provide the image, in response to the request, for use outside the secure environment.

18. The system of claim 17, wherein the 3D model is generated using procedural generation, and wherein information indicating one or more aspects of the procedural generation is stored using the verifiable ledger.

19. The system of claim 18, wherein the information indicating one or more aspects of the procedural generation are stored using the verifiable ledger in protected form, the protected form allowing validation without public exposure.

20. The system of claim 17, wherein the system comprises at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
9 a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a system for performing generative AI operations using a large language model (LLM),
a collaborative content creation platform for 3D assets; or
a system implemented at least partially using cloud computing resources.
